(19) United States
(12) Patent Application Publication
(10) Pub. No.: US 2007/0035063 A1
(43) Pub. Date: Feb. 15, 2007

(54) Two-stage reaction injection molded golf ball

(76) Inventors: Gerald A. Lavallee, Belchertown, MA (US); Daniel Murphy, Chicopee, MA (US); Thomas J. Kennedy III, Wilbraham, MA (US); Vincent J. Simonds, Brimfield, MA (US); Thomas A. Veilleux, Charlton, MA (US)

Correspondence Address: MICHAEL A. CATANIA;CALLAWAY GOLF COMPANY, 2180 RUTHERFORD ROAD, CARLSBAD, CA, 92008-7328, US

(21) Appl. No.: 11/202,125

(22) Filed: Aug. 10, 2005

(51) Int. Cl. B29C 45/14; B29C 45/40

(52) U.S. Cl. 264/255; 264/278; 264/279; 264/279.1; 425/577

(57) ABSTRACT

Various reaction injection molding (“RIM”) processes and molding equipment are disclosed. In particular, a multi-stage molding process and molding assembly is disclosed for the production of layers or cores on golf balls. The process utilizes a collection of molds, including shuttle molds and/or molding assist members, that readily enables reaction injection molding of layer(s) on golf ball cores or intermediate golf ball assemblies.

### CROSS REFERENCES TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to manufacturing a golf ball. More specifically, the present invention relates to a manufacturing a golf ball cover layer through use of reaction injection molding.

2. Description of the Related Art

Golf balls are typically made by molding a core of elastomeric or polymeric material into a spheroid shape. Alternatively, wound cores comprising a solid, liquid or gel center encapsulated by elastomeric windings or thread also can be produced. A cover is then molded around the core. Sometimes, before the cover is molded about the core, an intermediate layer is molded about the core and the cover is then molded around the intermediate layer. The molding processes used for the cover and the intermediate layer are similar and usually involve either compression molding or injection molding techniques.

In compression molding, the golf ball core is inserted into a central area of a two piece die and pre-sized sections of cover material are placed in each half of the die, which then clamps shut. The application of heat and pressure molds the cover material about the core. Polymeric materials, or blends thereof, have been used for modem golfball covers because different grades and combinations have offered certain levels of hardness, damage resistance when the ball is struck with a club, and elasticity, thereby providing responsiveness when hit. Some of these materials facilitate processing by compression molding, yet disadvantages have arisen. These disadvantages include the presence of seams in the cover, which occur where the pre-sized sections of cover material were joined, and high process cycle times which are required to heat the cover material and complete the molding process.

Injection molding of golf ball covers arose as a processing technique to overcome some of the disadvantages of compression molding. The process involves inserting a golf ball core into a die, closing the die and forcing a heated, viscous polymeric material into the die. The material is then cooled and the golf ball is removed from the die. Injection molding is well-suited for thermoplastic materials, but has generally limited applications with some thermosetting polymers. However, several types of these thermosetting polymers often exhibit the hardness and elasticity desired in golf ball cover construction.

Furthermore, some of the most promising thermosetting materials are reactive, requiring two or more components to be mixed and rapidly transferred into a die before a polymerization reaction is complete. As a result, traditional injection molding techniques do not provide proper processing when applied to these materials.

Reaction injection molding (“RIM”) is a processing technique used specifically for certain reactive thermosetting plastics. By “reactive” it is meant that the polymer is formed from two or more components which react. Generally, the components, prior to reacting, exhibit relatively low viscosities. The low viscosities of the components allow the use of lower temperatures and pressures than those utilized in traditional injection molding. In reaction injection molding, the two or more components are combined and react to produce the final polymerized material. Mixing of these separate components is critical, a distinct difference from traditional injection molding.

The process of reaction injection molding a golf ball cover or other component or layer, involves placing a golf ball core into a die, closing the die, injecting the reactive components into a mixing chamber where they combine, and transferring the combined material into the die. The mixing begins the polymerization reaction which is typically completed upon cooling of the cover material. Although satisfactory in many respects, there remains a need for an improved reaction injection molding process for forming golf balls.

Furthermore, there is a need for a new mold or die configuration and a new method of processing for reaction injection molding a golf ball cover or inner layer which promotes increased mixing of constituent materials, resulting in enhanced properties and the ability to explore the use of materials new to the golf ball art.

Additionally, during traditional molding operations in forming a cover or other layer on a golf ball core, a collection of locating pins are used within the mold cavity to retain the core in a fixed, central location within the mold cavity. Covers or other layers formed about such pins typically have voids resulting from the pins which then need to be filled or otherwise addressed. This additional step leads to increased processing and expense. Thus, it would also be desirable in certain circumstances to eliminate the use of locating pins when molding golf balls.

Moreover, after molding a cover or other layer on a golf ball core or intermediate golf ball assembly, the resulting molded assembly must be removed from the mold. Although mold release agents are known, disadvantages can arise from the use of such agents. Mechanical means are also known for removing the molded balls or assemblies from the mold. While sometimes satisfactory, a further need remains for new processes and techniques for removing a golf ball from a mold.

### BRIEF SUMMARY OF THE INVENTION

The present disclosure is directed, in various exemplary embodiments, to a two-stage reaction method for forming at least one layer on a golf ball core or intermediate golf ball assembly. The embodiments utilize a collection of molds, including shuttle molds and/or molding assist members, that enable the formation of golf ball components by reaction injection molding.

In one embodiment, the method comprises providing a first mold defining a recessed molding surface. The method also comprises providing a second mold defining a recessed retaining surface. The method further comprises positioning a golf ball core or intermediate golfball assembly within at least one of the recessed molding surface of the first mold and the recessed retaining surface defined by the second mold. The method also comprises closing or joining the first mold and the second mold whereby a first molding cavity is defined along a first region of the golf ball core or intermediate golf ball assembly. The method also comprises introducing an initially flowable material into the first molding cavity to thereby form a first molded layer portion on the first region. The method further comprises opening the first mold and the second mold to thereby at least partially expose the golfball core or intermediate golfball assembly. The method also comprises providing a third mold defining a recessed molding surface. The method further comprises positioning the golf ball core or intermediate golf ball assembly containing the first molded layer portion within at least one of the recessed molding surface of the first mold and the recessed molding surface of the third mold. The method also comprises closing the first mold and the third mold whereby a second molding cavity is defined along a second region of the golf ball core or intermediate golf ball assembly. The method further comprises introducing an initially flowable material into the second molding cavity to thereby form a second molded layer portion on the second region. The method also comprises opening the first mold and the third mold. And, the method comprises removing the golf ball core or the intermediate golf ball assembly containing the first and second molded layer portions, from at least one of the first mold and the third mold.

In another aspect, the exemplary embodiments provide a molding assembly adapted for two-stage reaction injection molding. The molding assembly comprises a first mold defining a recessed molding surface. The molding assembly also comprises a second mold defining a recessed retaining surface. The first mold and the second mold are adapted to engage each other to form a first molding cavity. The molding assembly also comprises a third mold defining a recessed molding surface. The first mold and the third mold are also adapted to engage each other to form a second molding cavity.

In yet another aspect according to the exemplary embodiments, a method of molding a layer formed of at least one flowable reactive material about a golf ball product is provided. The method comprises holding a first portion of the golf ball product in a retaining cavity of a retaining member to expose a second portion of the golf ball product. The method also comprises positioning the exposed second portion of the golf ball product in a first mold cavity of a first mold portion. The method further comprises injecting the reactive material at a mating surface between the retaining member and the first mold portion into the first mold cavity to mold a first portion of the layer over the second portion of the golf ball product.. The method also comprises disengaging the retaining member from the golf ball product to expose the first portion thereof while holding the molded first portion of the layer by the first mold portion. The method further comprises positioning the exposed first portion of the golf ball product in a second mold cavity of a second mold portion. The method also comprises injecting the reactive material at a mating surface between the first and second mold portions into the second mold cavity to mold a second portion of the layer over the first portion of the golf ball product. Additionally, the method comprises removing the golf ball product with the molded layer from the first and second molded portions.

In yet another aspect, the exemplary embodiments provide a method of molding a layer formed of at least one reaction injection molding material about each golf ball product in a multi-array of golf ball products. The method comprises holding a first portion of each golf ball product in a retaining cavity of a multi-array of a retaining member to expose a second portion of each golfball product. The method comprises positioning the exposed second portion of each golf ball product in a first mold portion which contains provisions for one or more cavities. The method also comprises molding a first portion of the layer from a reaction injection molding material over the second portion of each golfball product. The method further comprises disengaging the retaining member array from the golf ball product array to expose the first portion of each golf ball product while holding the molded first portions of the layers by the first mold portion array. The method also comprises positioning the exposed first portion of each golf ball product in a second mold cavity of a multi-array of second mold portions. The method further comprises molding a second portion of the layer from the reaction injection molding material over the first portion of each golf ball product. Moreover, the method also comprises removing the golfball product with the molded layer from the first and second molded portions.

In yet another aspect according to the exemplary embodiments, a method is provided for molding a layer formed of at least one reaction injection molding material about a golf ball product. The method comprises holding a bottom or side portion of the golf ball product horizontally, vertically or in any attitude or angle that facilitates molding in a retaining cavity of a retaining member to expose a top or side portion of the golf ball product. The method also comprises positioning the exposed top or side portion of the golfball product in a top mold cavity of a top mold portion or in another vertical mold. The method further comprises injecting the reaction injection molding material at a mating surface between the retaining member and the mold portion into the mold cavity to mold a top or side portion of the layer over the top or side portion of the golf ball product. The method further comprises disengaging the retaining member from the golfball product to expose the bottom or another side portion thereof while holding the molded top or side portion of the layer by the top or other vertical mold portion. The method further comprises positioning the exposed bottom or side portion of the golf ball product in a bottom or side mold cavity of a bottom or side mold portion. The method also comprises injecting the reaction injection molding material at a mating surface between the top and bottom or side mold portions into the bottom or side mold cavity to mold a bottom or side portion of the layer over the bottom or side portion of the golf ball product. And, the method comprises removing the golf ball product with the molded layer from the first and second molded portions.

One advantage of the exemplary embodiments is that the constituent materials are mixed thoroughly, thereby providing a more consistent intermediate and/or cover layer, resulting in better golf ball performance characteristics.

Another advantage of the exemplary embodiments is that the use of new, lower viscosity materials may be explored, resulting in enhanced golf ball properties and performance.

Yet another advantage of the exemplary embodiments is that increased mixing of lower viscosity materials allows the intermediate layer or cover to be thinner, resulting in increased ball performance.

Still another advantage of the exemplary embodiments is that enhanced core centering can be produced during the molding process. This results in a golfball that is more dependably concentric and uniform in construction, thereby improving ball performance.

A further advantage of the exemplary embodiments results from the elimination of locating or support pins used in certain previous processes that can otherwise detrimentally affect cosmetics and resulting durability of the golf ball.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a first embodiment of a three-piece golf ball formed according to a reaction injection molded (RIM) process according to the exemplary embodiment.

FIG. 2 is a second embodiment of a three-piece golfball formed according to a reaction injection molded (RIM) process according to the exemplary embodiment.

FIG. 3 is a third embodiment of a four-piece golf ball formed according to a reaction injection molded (RIM) process according to the exemplary embodiment.

FIG. 3A is another embodiment of a two-piece golf ball formed according to a reaction injection molded (RIM) process according to the exemplary embodiment.

FIG. 3B is another embodiment of a four-piece golf ball formed according to a reaction injection molded (RIM) process according to the exemplary embodiment.

FIG. 3C is another embodiment of a five-piece golfball formed according to a reaction injection molded (RIM) process according to the exemplary embodiment.

FIG. 3D is another embodiment of a five-piece golf ball formed according to a reaction injection molded (RIM) process according to the exemplary embodiment.

FIG. 4 is a process flow diagram which schematically depicts a reaction injection molding process according to the exemplary embodiment.

FIG. 5 schematically shows a mold for reaction injection molding a golf ball cover according to the exemplary embodiment.

FIG. 6 is a perspective view revealing the components of a preferred golf ball in accordance with the exemplary embodiment

FIG. 7 is a perspective view of another preferred molding assembly in accordance with the exemplary embodiment.

FIG. 8 is a planar view of a portion of the preferred molding assembly taken along line 3-3 in FIG. 7.

FIG. 9 is a planar view of a portion of the preferred molding assembly taken along line 4-4 in FIG. 7.

FIG. 10 is a detailed perspective view of a portion of the preferred molding assembly taken along line 5-5 in FIG. 7. This view illustrates a turbulence-promoting peanut mixer in accordance with the exemplary embodiment.

FIG. 11 is a detailed view of the peanut mixer of the preferred molding assembly in accordance with the exemplary embodiment.

FIG. 12 is a planar view of a portion of an alternative embodiment of the molding assembly in accordance with the exemplary embodiment.

FIG. 13 is a planar view of a portion of an alternative embodiment of the molding assembly in accordance with the exemplary embodiment.

FIG. 14 is a planar view of a portion of an alternative embodiment of the molding assembly in accordance with the exemplary embodiment.

FIG. 16 is a cross-sectional schematic view of a portion of another mold in accordance with the exemplary embodiment.

FIG. 17 is a cross-sectional schematic view of another mold and a golf ball core positioned within the mold portion according to the exemplary embodiment.

FIG. 18 is a cross-sectional schematic view of the two mold portions depicted in

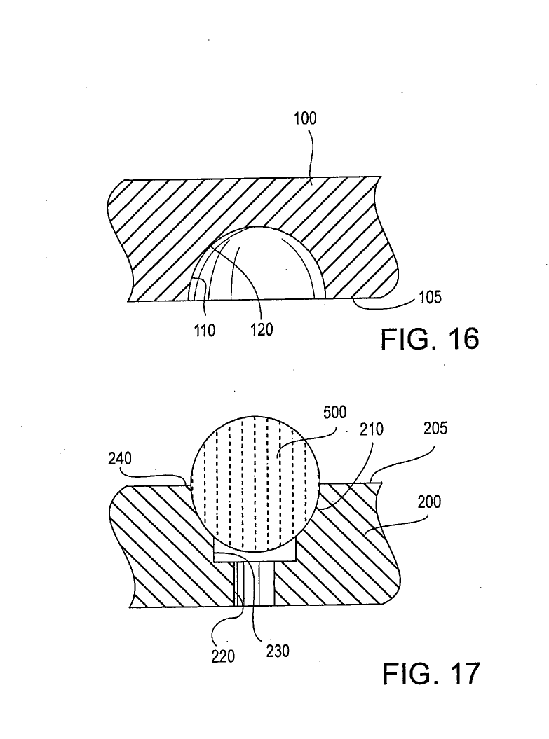

FIGS. 16 and 17 closed and housing the golf ball core according to the exemplary embodiment.

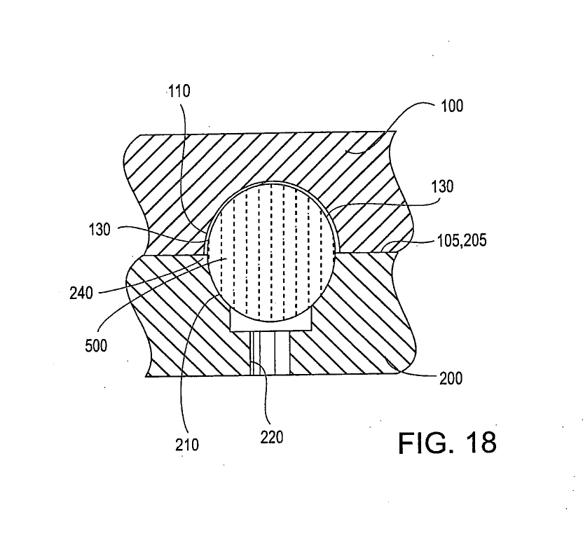

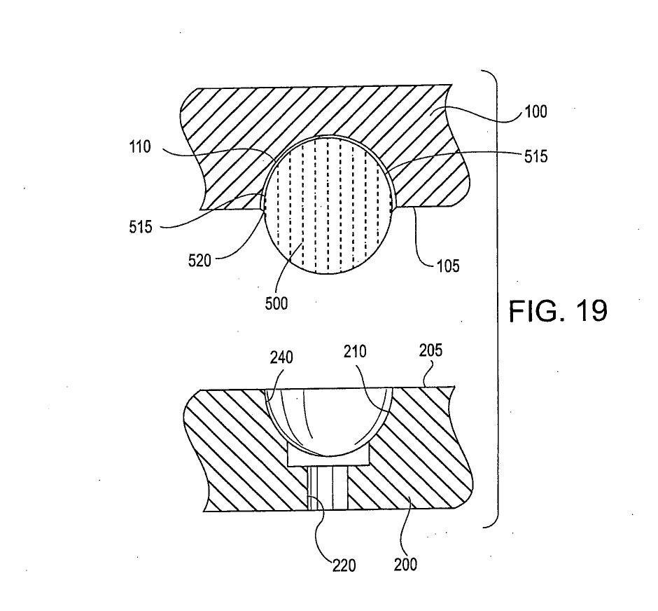

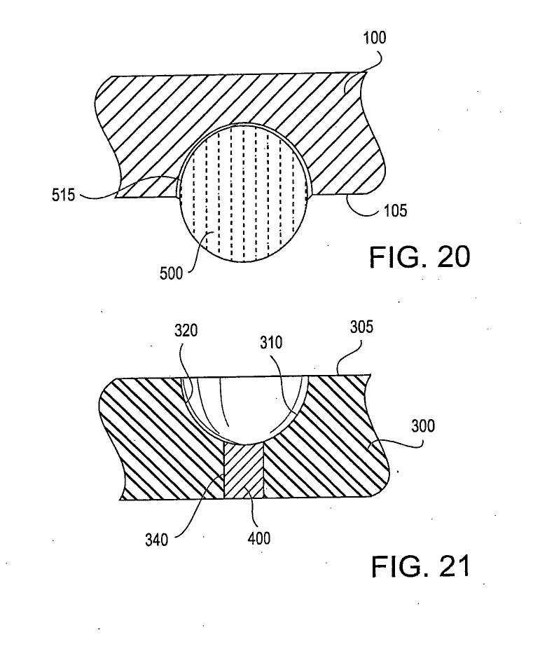

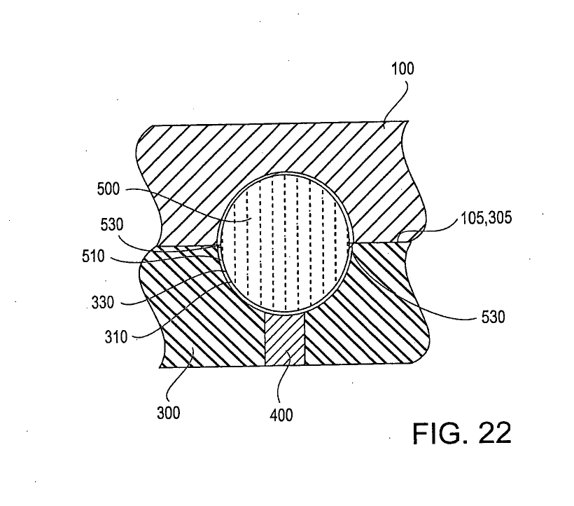

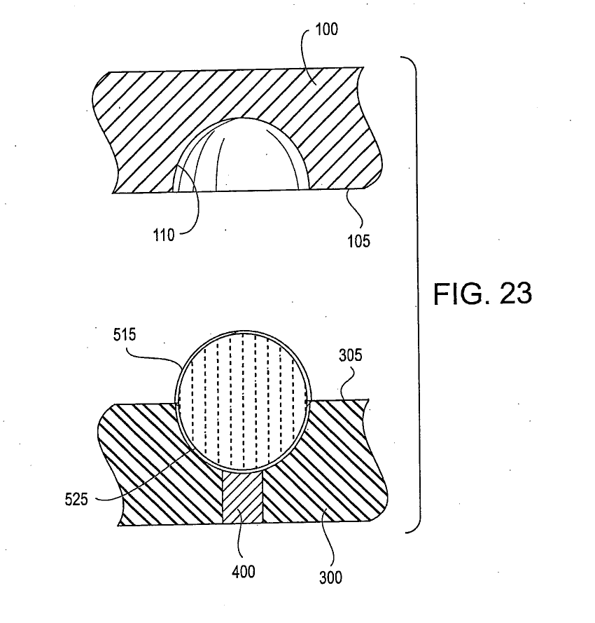

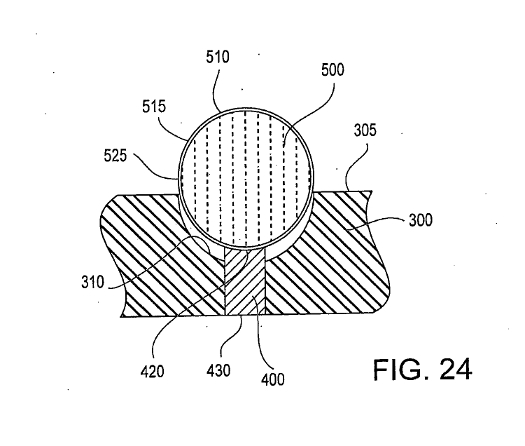

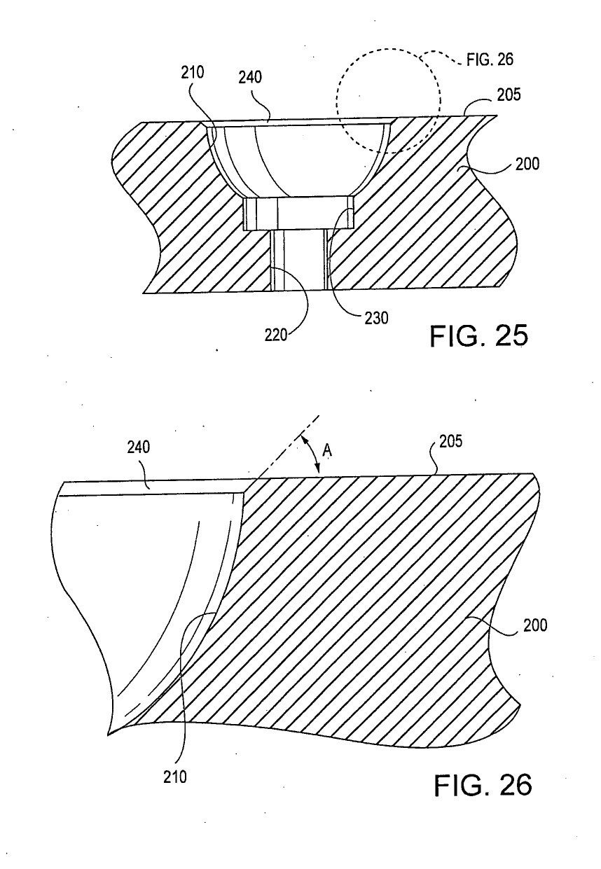

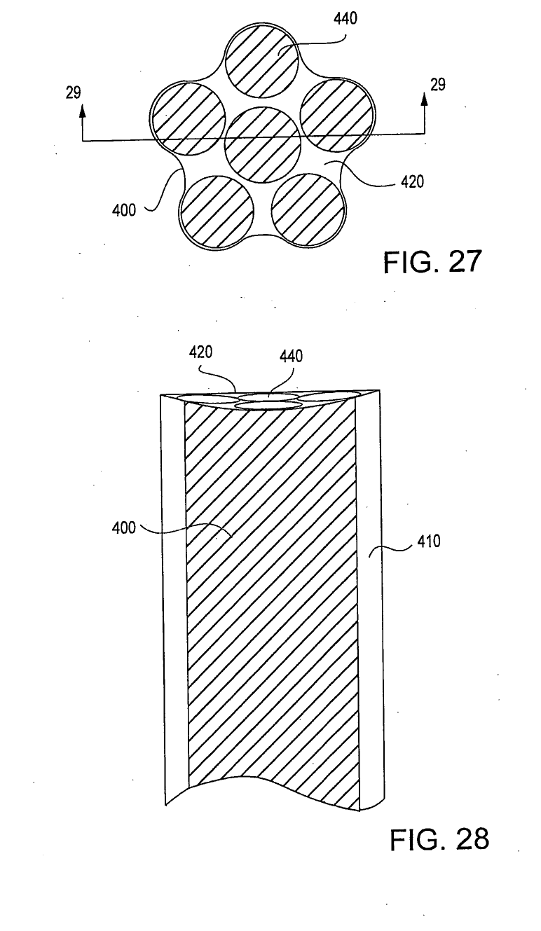

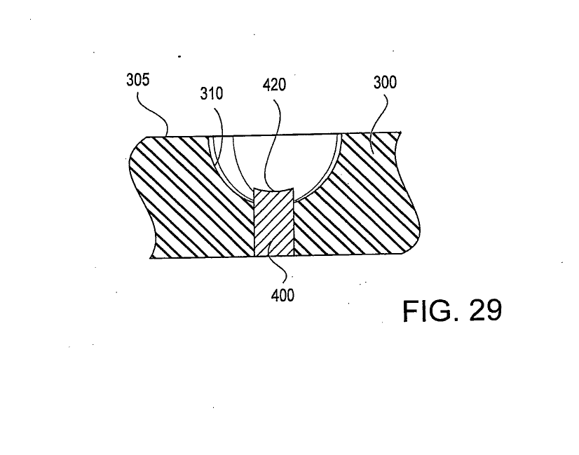

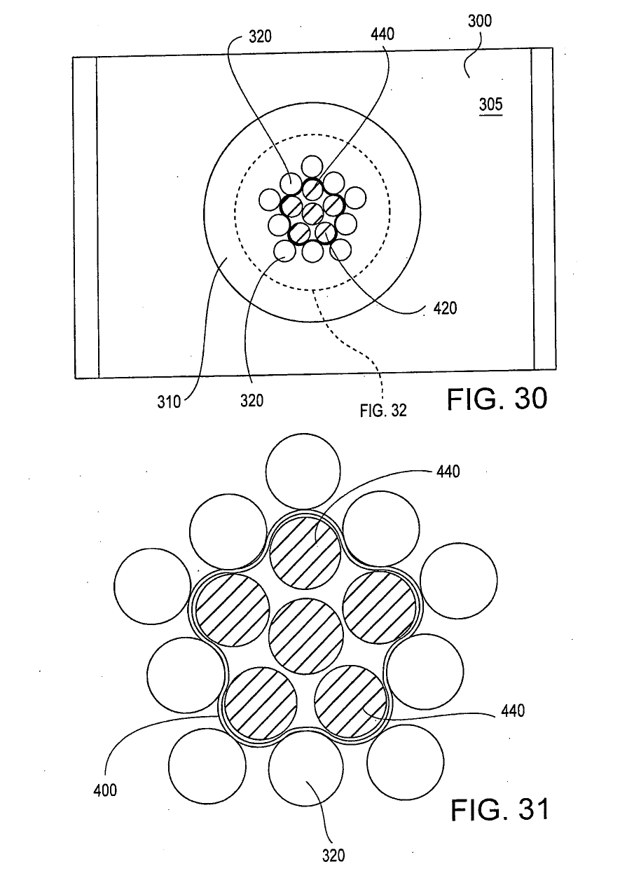

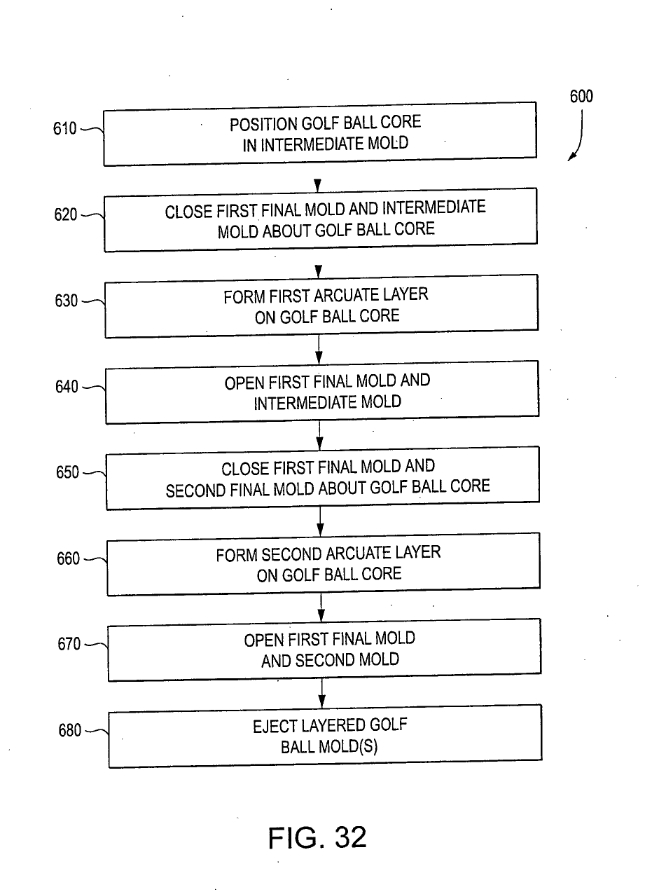

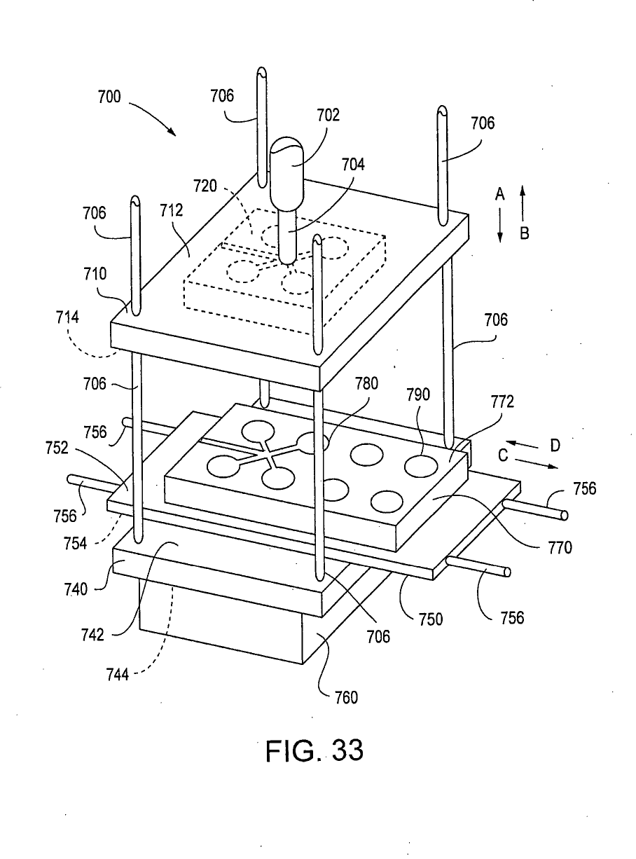

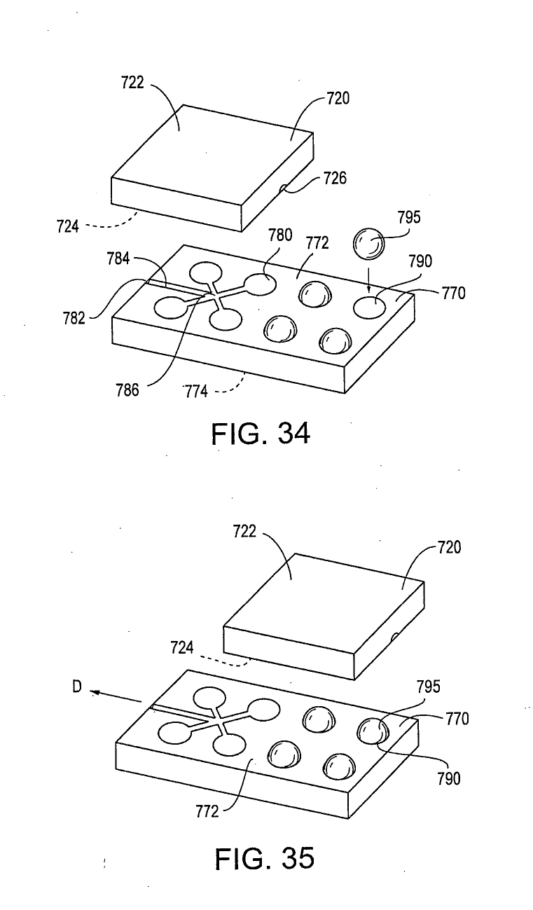

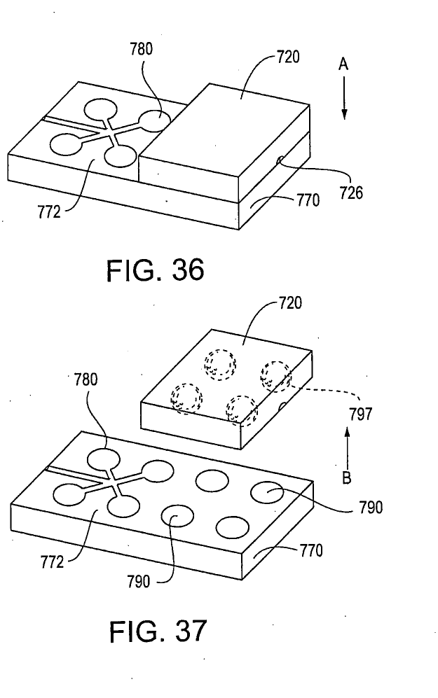

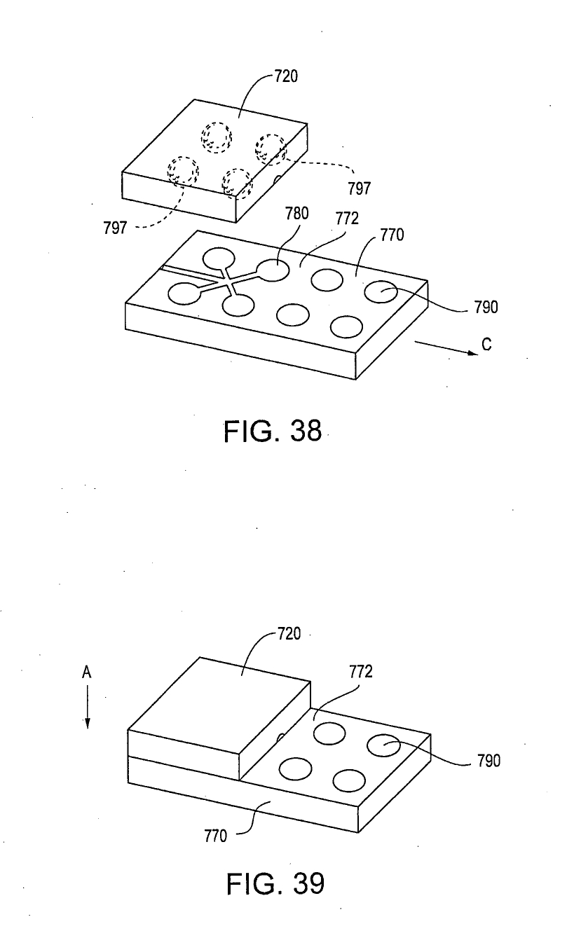

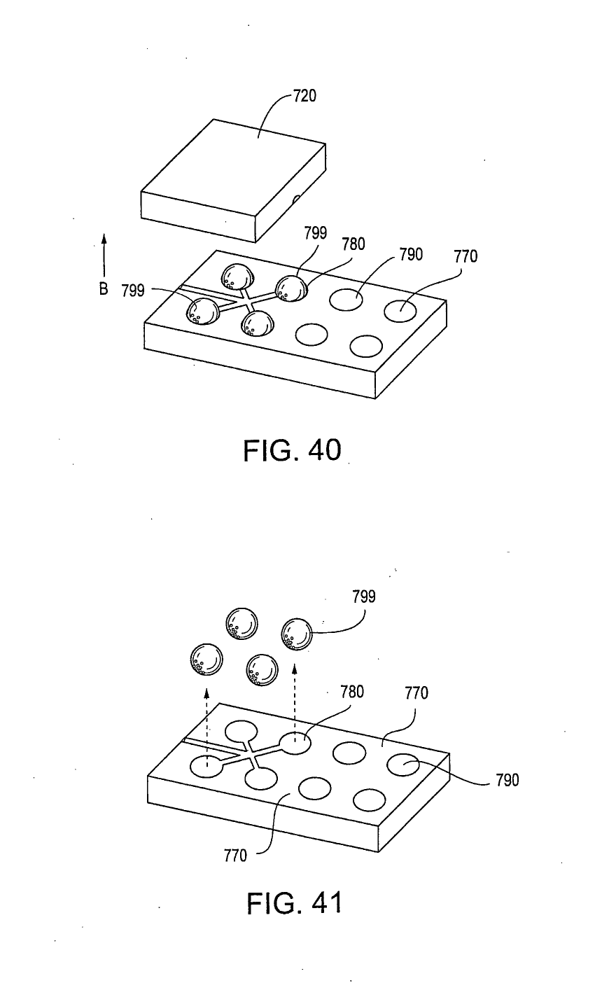

FIG. 19 illustrates the molds and golf ball core of FIG. 18 upon separating the two molds from one another according to the exemplary embodiment.

FIG. 20 illustrates the golf ball and outer layer portion molded on the core, retained in the first mold portion shown in FIG. 19.

FIG. 21 is a cross-sectional schematic view of another preferred mold according to the exemplary embodiment.

FIG. 22 illustrates the mold of FIG. 21 and the golf ball core retained in the first mold of FIG. 19 brought together to house the golf ball core and layer portion in accordance with the exemplary embodiment.

FIG. 23 illustrates the molds of FIG. 22 upon separation from one another.

FIG. 24 illustrates ejection of the golf ball core and completed layer molded about the core from the mold components in FIG. 23.

FIG. 25 is a detailed cross-sectional schematic view of the second mold of FIG. 17 illustrating particular aspects of the mold configuration according to the exemplary embodiment.

FIG. 26 is a detailed view of a release lip formed along the perimeter of the mold of FIG. 25.

FIG. 27 is a planar and partial cross-sectional view of an optional embodiment ejection pin according to the exemplary embodiment.

FIG. 28 is a side elevational and partial cross-sectional view of the preferred embodiment release pin depicted in FIG. 27.

FIG. 29 is a schematic cross-sectional view of the mold component of FIG. 24 and the release pin slidably positioned within that mold component.

FIG. 30 is a planar view of the mold component depicted in FIG. 29 illustrating the location of the release pin relative to a molding cavity.

FIG. 31 is a detailed view of the distal tip of the release pin.

FIG. 32 is a flow chart illustrating another preferred process in accordance with the exemplary embodiment.

FIG. 33 is a schematic perspective view of a preferred embodiment golfball shuttle mold assembly in accordance with the exemplary embodiment.

FIG. 34 is an illustration of the relative positions of two molding members of the assembly depicted in FIG. 33 during a molding operation according to the exemplary embodiment.

FIG. 35 illustrates displacement and repositioning of one of the molding members of FIG. 34.

FIG. 36 illustrates a first molding operation in which a first hemispherical cover portion is formed.

FIG. 37 illustrates disengagement of the molding members and repositioning of one with respect to the other.

FIG. 38 illustrates further repositioning of the molding members.

FIG. 39 illustrates engagement and a second molding operation in which a second hemispherical cover portion is formed.

FIG. 40 illustrates disengagement of the molding members.

FIG. 41 illustrates ejection of golf balls from one of the molding members after completion of the molding process.

### DETAILED DESCRIPTION OF THE INVENTION

Disclosed herein, in various exemplary embodiments, are golf balls in which at least one cover layer, intermediate mantle layer, or core layer comprises a fast-chemical-reaction-produced component. This component comprises particular polyurethane, polyurethane/polyurea, and polyurea compositions, and preferably comprises thermosetting polyurethanes, polyurethanes/polyureas, and polyureas. The phrase “polyurethane/polyurea” will be used herein to mean a polyurethane, a polyurea, or combination thereof.

The exemplary embodiments also include methods of producing golf balls, such as by RIM, which contain a fast-chemical-reaction-produced component. The exemplary embodiments additionally include methods for performing two stage molding operations for forming layers or covers on golf ball cores or intermediate golf ball assemblies. Particularly preferred forms of the exemplary embodiments also provide for a golf ball with a thin, fast-chemical-reaction-produced cover having good scuff and cut resistance. And, the exemplary embodiments provide unique molds, mold configurations, and combinations of molds that enable the exemplary embodiments' methods to be performed.

More specifically, one of the preferred methods of forming a fast-chemical-reaction-produced component for a golf ball according to the disclosure is by a modified RIM process. In a RIM process, highly reactive liquids are injected into a closed mold, mixed usually by impingement and/or mechanical mixing and secondarily mixed in an in-line device such as a peanut mixer, where they polymerize primarily in the mold to form a coherent, molded article. The RIM processes usually involve a rapid reaction between one or more reactive components such as polyether- or polyester-polyol, polyamine, or other material with an active hydrogen, and one or more isocyanate-containing constituents, often in the presence of a catalyst. The constituents are stored in separate tanks prior to molding and may be first mixed in a mix head upstream of a mold and then injected into the mold. The liquid streams are metered in the desired weight to weight ratio, such that the ratio of the —NCO groups to the active hydrogen groups is within a desired ratio, and fed into an impingement mix head, with mixing occurring under high pressure, e.g., 1500 to 3000 psi. The liquid streams impinge upon each other in the mixing chamber of the mix head and the mixture is injected into the mold. One of the liquid streams typically contains a catalyst for the reaction. The constituents react rapidly after mixing to gel and form polyurethane/polyurea polymers. Epoxies and various unsaturated polyesters also can be molded by RIM.

RIM differs from non-reaction injection molding in a number of ways. The main distinction is that in RIM a chemical reaction takes place in the mold to transform a monomer or adducts to polymers and the components are in liquid form. Thus, a RIM mold need not be made to withstand the pressures which occur in a conventional injection molding. In contrast, injection molding is conducted at high molding pressures in the mold cavity by melting a solid resin and conveying it into a mold, with the molten resin often being at about 150 to about 350° C. At this elevated temperature, the viscosity of the molten resin usually is in the range of 50,000 to about 1,000,000 centipoise, and is typically around 200,000 centipoise. In an injection molding process, the solidification of the resins occurs after about 10 to 90 seconds, depending upon the size of the molded product, the temperature and heat transfer conditions, and the hardness or crystalline content of the injection molded material. Subsequently, the molded product is removed from the mold. There is no significant chemical reaction taking place in an injection molding process when the thermoplastic resin is introduced into the mold. In contrast, in a RIM process, the chemical reaction typically takes place in less than about 2 minutes, preferably in under one minute, and in many cases in about 30 seconds or less.

The fast-chemical-reaction-produced component has a flex modulus of from about 1 to about 310 kpsi, more preferably from about 1 to about 100 kpsi, and most preferably from about 2 to about 50 kpsi. The subject component can be a cover with a flex modulus which is higher than that of the centermost component of the cores, as in a liquid center core and some solid center cores. Furthermore, the fast-chemical-reaction-produced component can be a cover with a flex modulus that is higher than that of the immediately underlying layer, as in the case of a wound core. The core can be one piece or multi-layer, filled or unfilled, wound or non-wound, and each layer can be either foamed or unfoamed. Furthermore, density adjusting fillers, including metals, can also be used. The cover of the ball can be harder or softer than any particular core layer.

The fast-chemical-reaction-produced component can incorporate suitable additives and/or fillers. When the component is an outer cover layer, pigments or dyes, accelerators and UV stabilizers can be added. Examples of suitable optical brighteners which probably can be used include Uvitex™ and Eastobrite™ OB-1. An example of a suitable white pigment is titanium dioxide. Examples of suitable and UV light stabilizers are provided in commonly assigned U.S. Pat. No. 5,494,291. Fillers which can be incorporated into the fast-chemical-reaction-produced cover or core component include those listed below in the definitions section. Furthermore, compatible polymeric materials can be added. For example, when the component comprises polyurethane and/or polyurea, such polymeric materials include polyurethane ionomers, polyamides, etc.

Catalysts can be added to the RIM polyurethane system starting materials as long as the catalysts generally do not react with the constituent with which they are combined. Suitable catalysts include those which are known to be useful with polyurethanes and polyureas. These catalyst include dibutyl tin dilaurate or triethylenediamine.

The reaction mixture viscosity should be sufficiently low to ensure that the empty space in the mold is completely filled. The reactant materials generally are preheated to about 80° F. to about 200° F. and preferably to 100° F. to about 180° F. before they are mixed. In most cases it is necessary to preheat the mold to, e.g., from about 80° F. to about 200° F., to provide for proper injection viscosity and system reactivity.

Molding at lower temperatures is beneficial when, for example, the cover is molded over a core. Normally, at higher temperature molding processes, the core may expand during molding. Such core expansion is not of such a concern when molding at lower temperatures and lower cycle times utilizing RIM.

As indicated above, one or more layers of a golf ball can be formed from a fast-chemical-reaction-produced material according to the present disclosure. These layers are preferably formed from polyurethane/polyurea materials.

Polyurethanes/polyureas are polymers which are used to form a broad range of products. Polyurethane and/or polyurea polymers are typically made from three reactants: alcohols, amines, and isocyanate-containing compounds.. They react with the isocyanate-containing compound, which is generally referred to as an “isocyanate.” The constituent containing the alcohols, amines or other reactive hydrogen groups is sometimes referred to collectively as the polyol constituent of the RIM formulation. The constituent containing the isocyanate or isocyanate prepolymer is usually referred to as the isocyanate constituent of the RIM formulation.

Several chemical reactions may occur during polymerization of isocyanate and polyol. Isocyanate groups (—N═C═O) that react with alcohols form a polyurethane, whereas isocyanate groups that react with an amine group form a polyurea. A polyurethane itself may react with an isocyanate to form an allophanate and a polyurea can react with an isocyanate to form a biuret. Because the biuret and allophanate reactions occur on an already-substituted nitrogen atom of the polyurethane or polyurea, these reactions increase cross-linking within the polymer. The polyol component typically contains additives, such as stabilizers, flow modifiers, catalysts, combustion modifiers, blowing agents, fillers, pigments, optical brighteners, surfactants and release agents to modify physical characteristics of the cover. Polyurethane/polyurea constituent molecules that were derived from recycled polyurethane can be added in the polyol component. Cross linking occurs between the isocyanate groups (—NCO) and the polyol's hydroxyl end-groups (—OH) and/or the active hydrogens (—H) of the amines or polyamines. Additionally, the end-use characteristics of polyurethanes can also be controlled by different types of reactive chemicals and processing parameters. For example, catalysts are utilized to control polymerization rates. Depending upon the processing method, reaction rates can be very quick (as in the case for some reaction injection molding systems (i.e., “RIM”).

A wide range of combinations of polyisocyanates and polyols, as well as other ingredients, are available. Furthermore, the end-use properties of polyurethanes can be controlled by the type of polyurethane utilized, i.e., whether the material is thermoset (cross linked molecular structure) or thermoplastic (linear molecular structure). In the present RIM process, thermosetting polyurethanes/polyureas are utilized.

In this regard, polyurethanes are typically classified as thermosetting or thermoplastic. A polyurethane becomes irreversibly “set” when a polyurethane prepolymer is cross linked with a polyfunctional curing agent, such as a polyamine or a polyol. The prepolymer typically is made from polyether or polyester. Diisocyanate polyethers are sometimes preferred because of their water resistance.

The physical properties of thermoset polyurethanes are controlled substantially by the degree of cross linking. Tightly cross linked polyurethanes/polyureas are fairly rigid and strong. A lower amount of cross linking results in materials that are flexible and resilient. Thermoplastic polyurethanes have some cross linking, but primarily by physical means. The crosslinkings bonds can be reversibly broken by increasing temperature, as occurs during molding or extrusion. Polyurethane materials suitable for the exemplary embodiments are formed by the reaction of a polyisocyanate, a polyol, an amine and optionally one or more chain extenders. The polyol component includes any suitable polyether- or polyester polyol. Additionally, in an alternative embodiment, the polyol component may contain polybutadiene diol as a chain extender. The chain extenders include, but are not limited, to diols, triols and amine extenders. Any suitable polyisocyanate may be used to form a polyurethane according to the exemplary embodiment. The polyisocyanate is preferably selected from the group of diisocyanates including, but not limited, to 4,4N-diphenylmethane diisocyanate (“MDI”); 2,4-toluene diisocyanate (“TDI”); m-xylylene diisocyanate (“XDI”); methylene bis-(4-cyclohexyl isocyanate) (“HMDI”); hexamthylene diisocyanate (HDI); naphthalene-1,5,-diisocyanate (“NDI”); 3,3N-dimethyl-4,4N-biphenyl diisocyanate (“TODI”); 1 ,4-diisocyanate benzene (“PPDI”); phenylene-l ,4-diisocyanate; and 2,2,4-or 2,4,4-trimethyl hexamethylene diisocyanate (“TMDI”).

Other less preferred diisocyanates include, but are not limited to, isophorone diisocyanate (“IPDI”); 1,4-cyclohexyl diisocyanate (“CHDI”); diphenylether-4,4N-diisocyanate; p,pN-diphenyl diisocyanate; lysine diisocyanate (“LDI”); 1,3-bis (isocyanato methyl) cyclohexane; and polymethylene polyphenyl isocyanate (“PMDI”).

One polyurethane component which can be used in the exemplary embodiment incorporates TMXDI (META) aliphatic isocyanate (Cytec Industries, West Paterson, N.J.). Polyurethanes based on meta-tetramethylxylyliene diisocyanate can provide improved gloss retention, UV light stability, thermal stability and hydrolytic stability. Additionally, TMXDI (META) aliphatic isocyanate has demonstrated favorable toxicological properties. Furthermore, because it has a low viscosity, it is usable with a wider range of diols (to polyurethane) and diamines (to polyureas). If TMXDI is used, it typically, but not necessarily, is added as a direct replacement for some or all of the other aliphatic isocyanates in accordance with the suggestions of the supplier. Because of slow reactivity of TMXDI, it may be useful or necessary to use catalysts to have practical demolding times. Hardness, tensile strength and elongation can be adjusted by adding further materials in accordance with the supplier's instructions.

Suitable glycol chain extenders include, but are not limited to ethylene glycol; propane glycol; butane glycol; pentane glycol; hexane glycol; benzene glycol; xylenene glycol; 1,4-butane diol; 1,3-butane diol; 2,3-dimethyl-2,3-butane diol; and dipropylene glycol. Suitable amine extenders include, but are not limited to, tetramethyl-ethylenediamine; dimethylbenzylamine; diethylbenzylamine; pentamethyldiethylenetriamine; dimethyl cyclohexylamine; tetramethyl-1,3-butanediamine; 1,2-dimethylimidazole; 2-methylimidazole; pentamethyldipropylenetriamine; diethyl toluene diamine (DETDA) and bis-(dismethylaminoethylether).

Polyurethane/polyurea compositions of the exemplary embodiment are especially desirable as materials in forming golfballs. Polyurethanes according to the exemplary embodiment, are suitable materials for any of a core layer, a mantle layer, and a cover layer. Most preferably, the polyurethane materials are used to form a cover layer. Accordingly, golf balls according to the exemplary embodiment, may be formed as two-piece, or multi-layer balls having a wound core a solid, non-wound core, a liquid core, or a thermoplastic non-wound core. In a preferred form, golf balls utilizing a polyurethane composition described herein are solid, i.e., non-wound, multi-layer golf balls comprising a solid non-wound core, a cover formed from the exemplary embodiment polyurethane, and one or more intermediate layers disposed between the cover and the core. Specifically, multi-layer golfballs can be produced by injection molding or compression molding a mantle layer about wound or solid molded cores to produce an intermediate golf ball core or insert having a diameter of about 1.50 to 1.67 inches, preferably about 1.620 inches. The cover layer is subsequently molded over the mantle layer to produce a golf ball having a diameter of 1.680 inches or more. Although either solid, wound, liquid, foamed or thermoplastic non-wound cores can be used in the exemplary embodiment, as a result of their lower cost and superior performance, solid molded cores are preferred over wound cores.

A preferred form of the exemplary embodiments is a golf ball in which at least one cover, intermediate or core layer comprises a fast-chemical-reaction-produced component. This component includes at least one material selected from the group consisting of polyurethane/polyurea, polyurethane ionomer, epoxy, and unsaturated polyesters, and preferably comprises polyurethane. The exemplary embodiment also includes a method of producing a golf ball which contains a fast-chemical-reaction-produced component. A golf ball formed according to the exemplary embodiment preferably has a flex modulus in the range of from about 1 to about 310 kpsi, a Shore D hardness in the range of from about 10 to about 95, and good durability. The Shore B readings, when measured on the ball, are 50 to 100. Particularly preferred forms of the exemplary embodiment also provide for a golfball with a fast-chemical-reaction-produced cover having good scuff resistance and cut resistance.

As indicated above, the fast-chemical-reaction-produced component can be one or more cover and/or core layers of the ball. When a polyurethane/polyurea cover is formed according to the exemplary embodiment, and is then covered with a polyurethane top coat, excellent adhesion can be obtained. The adhesion in this case is better than adhesion of a polyurethane coating to an ionomeric cover. This improved adhesion can result in the use of a thinner top coat, the elimination of a primer coat, and the use of a greater variety of golf ball printing inks beneath or on top of the top coat. These include but are not limited to typical inks such as one component polyurethane inks and two component polyurethane inks.

A more complete understanding of the processes, products, components and apparatuses disclosed herein can be obtained by reference to the accompanying drawings. These figures are merely schematic representations based on convenience and the ease of demonstrating the present development, and are, therefore, not intended to indicate relative size and dimensions of the golf balls or components thereof.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

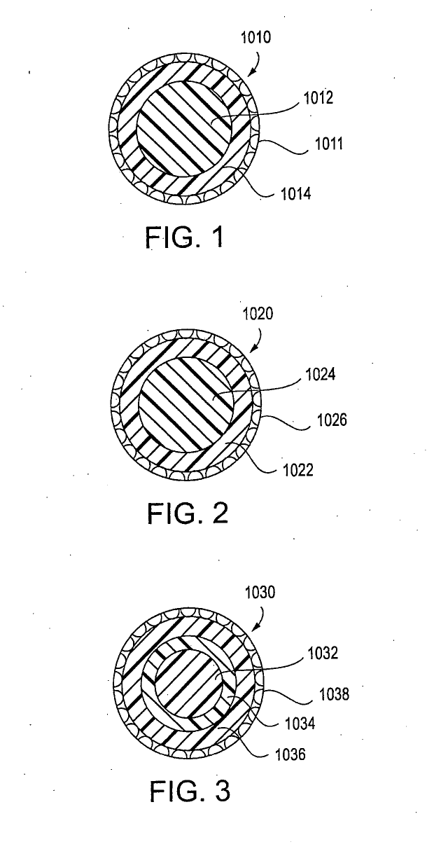

Referring now to the drawings, and first to FIG. 1, a golfball having a cover comprising a RIM polyurethane/polyurea is shown. The golf ball 1010 includes a polybutadiene core 1012, a thermoplastic or thermoset mantle 1014, and a polyurethane/polyurea cover 1011 formed by RIM. Referring now to FIG. 2, a golf ball having a core comprising a RIM polyurethane/polyurea is shown. The golf ball 1020 has a RIM polyurethane/polyurea core 1024, a thermoplastic or thermoset mantle 1022, and a RIM polyurethane/polyurea cover 1026.

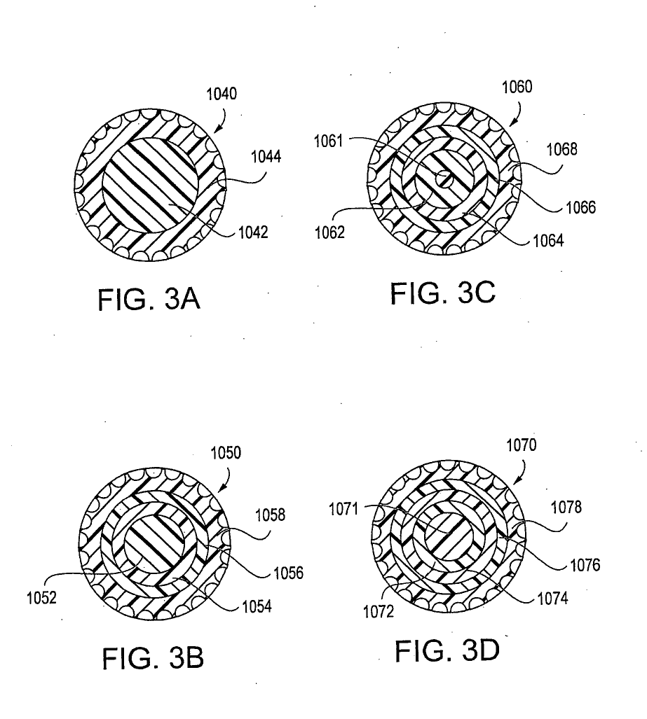

Referring to FIG. 3, a multi-layer golf ball 1030 is shown with a solid inner core 1032 containing polybutadiene and/or recycled RIM polyurethane/polyurea, an outer core layer 1034 comprising polybutadiene and/or RIM polyurethane/polyurea, and an inner cover layer 1036, and an outer cover layer 1038. The inner and outer cover layers comprise ionomer or other conventional golfball cover materials. Such golfball cover materials typically contain titanium dioxide utilized to make the cover white in appearance. Non-limiting examples of multi-layer golf balls according to the exemplary embodiment with two cover layers include those with RIM polyurethane/polyurea materials having a thickness of from about 0.01 to about 0.20 inches and a Shore D hardness of 10 to 95, ionomeric or non-ionomeric thermoplastic, balata or other cover materials having a Shore D hardness of from about 10 to about 95 and a thickness of 0.020 to 0.20 inches.

FIG. 3A illustrates a two-piece golf ball 1040 comprising a core 1042 and a single core layer 1044 disposed on and about the core 1042. Either or both of the core and the layer can be formed from the noted polyurethane/polyurea. The core can optionally be formed from a polybutadiene.

FIG. 3B illustrates a four-piece golfball 1050 comprising a core 1052, a first cover layer 1054 disposed on the core, a second cover layer 1056 disposed on the first layer 1054, and a third cover layer 1058 disposed on the second cover layer. One or more of the core. 1052, and cover layers 1054, 1056, and 1058 can be formed from the noted polyurethane/polyurea. The core can optionally be formed from a polybutadiene.

FIG. 3C illustrates a five-piece golfball 1060 comprising an inner core component 1061 and an outer core component or core layer 1062. The ball 1060 also comprises a first cover layer 1064 disposed about the core, and immediately adjacent to the core layer 1062. Disposed on the first cover layer 1064 is a second cover layer 1066. The ball 1060 also comprises a third cover layer 1068 disposed on the second cover layer 1066. One or more of the core components 1061 and 1062, and the cover layers 1064, 1066, and 1068 can be formed from the polyurethane/polyurea described herein. The core components can also optionally be formed from polybutadiene.

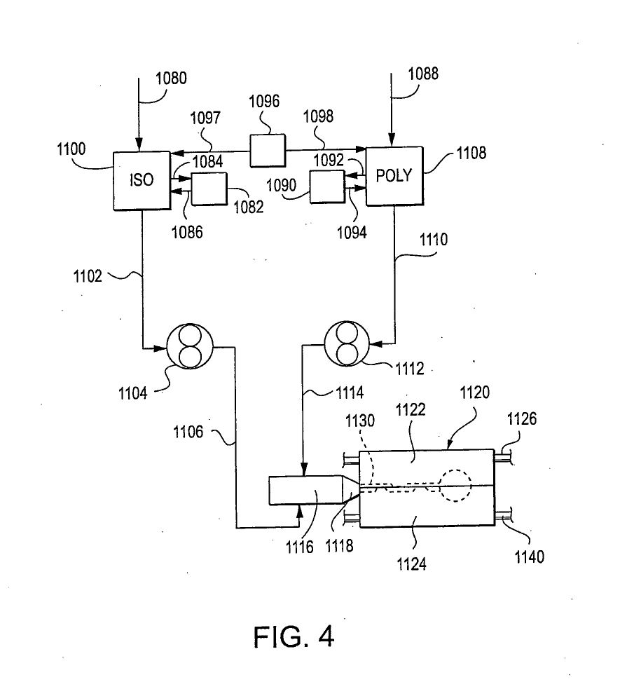

FIG. 3D illustrates a five-piece golf ball 1070 comprising a core 1071 and four cover layers 1072, 1074, 1076, and 1078. One or more of the core and cover layers can be formed from the noted polyurethane/polyurea. Optionally, the core can be formed from polyubtadiene. Referring next to FIG. 4, a process flow diagram for forming a RIM cover of polyurethane/polyurea is shown. Isocyanate from bulk storage is fed through line 1080 to an isocyanate tank 1100. The isocyanate is heated to the desired temperature, e.g. 90 to about 150° F., by circulating it through heat exchanger 1082 via lines 1084 and 1086. Polyol, polyamine, or another compound with an active hydrogen atom is conveyed from bulk storage to a polyol tank 1108 via line 1188. The polyol is heated to the desired temperature, e.g. 90 to about 150° F., by circulating it through heat exchanger 1090 via lines 1092 and 1094. Dry nitrogen gas is fed from nitrogen tank 1096 to isocyanate tank 1100 via line 1097 and to polyol tank 1108 via line 1098. Isocyanate is fed from isocyanate tank 1100 via line 1102 through a metering cylinder or metering pump or combinations thereof 1104 into recirculation mix head inlet line 1106. Polyol is fed from polyol tank 1108 via line 1110 through a metering cylinder or metering pump or combinations thereof 1112 into a recirculation mix head inlet line 1114. The recirculation mix head 1116 receives isocyanate and polyol, mixes them, and provides for them to be fed through nozzle 1118 into injection mold 1120. The injection mold 1120 has a top mold 1122 and a bottom mold 1124. Mold heating or cooling can be performed through lines 1126 in the top mold 1122 and lines 1140 in the bottom mold 1124. The materials are kept under controlled temperature conditions to insure that the desired reaction profile is maintained. The polyol component typically contains additives, such as stabilizers, flow modifiers, catalysts, combustion modifiers, blowing agents, fillers, pigments, optical brighteners, surfactants and release agents to modify physical characteristics of the cover. Recycled polyurethane/polyurea also can be added to the core. Polyurethane/polyurea constituent molecules that were derived from recycled polyurethane/polyurea can be added in the polyol component.

Inside the mix head 1116, injector nozzles impinge the isocyanate and polyol at ultra-high velocity to provide excellent mixing. Additional mixing preferably is conducted using an aftermixer 1130, which typically is constructed inside the mold between the mix head and the mold cavity. The molding assembly is positionable between an open state in which the interior or contents of the mold are accessible, and a closed state in which the molding cavity or molding chamber is enclosed and defines a sealed interior or void, such as when receiving flowable molding material in a molding operation. The molding assembly can be closed or otherwise positioned to a closed state by moving the molding members in nearly any direction or along nearly any axis. For example, the molding members can be positioned along a vertical axis, a horizontal axis, or any axis therebetween.

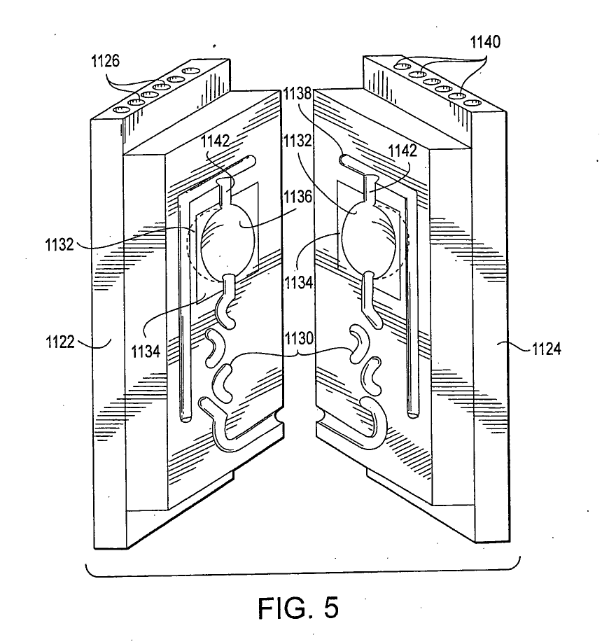

As is shown in FIG. 5, the mold includes a golf ball cavity chamber 1132 in which a spherical golf ball cavity 1134 with a dimpled, inner spherical surface 1136 is defined. The aftermixer 1130 can be a peanut aftermixer, as is shown in FIG. 5, or in some cases another suitable type, such as a heart, harp or dipper. However, the aftermixer does not have to be incorporated into the mold design. An overflow channel 1138 receives overflow material from the golf ball cavity 1134 through a shallow vent 1142. Heating/cooling passages 1126 and 1140, which preferably are in a parallel flow arrangement, carry heat transfer fluids such as water, oil, etc. through the top mold 1122 and the bottom mold 1124.

The mold cavity may contain retractable pins and is generally constructed in the same manner as a mold cavity used to injection mold a thermoplastic, e.g., ionomeric golf ball cover. However, two differences when RIM is used are that tighter pin tolerances generally are required, and a lower injection pressure is used. Also, the molds can be produced from lower strength material such as aluminum.

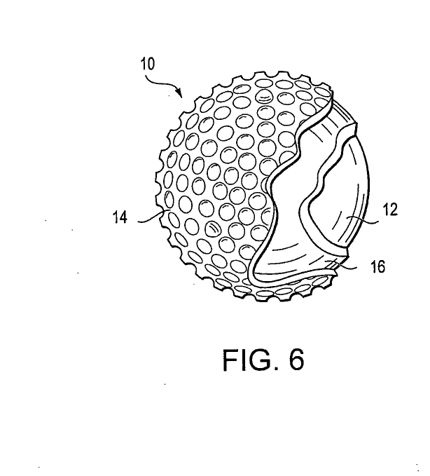

In FIG. 6, another preferred embodiment golf ball 10 in accordance with the exemplary embodiment is illustrated. The golf ball 10 includes a central core 12 which may be solid or liquid filled as known in the art. A cover 14 is surroundingly disposed about the central core 12. An intermediate layer 16 may be present between the central core 12 and the cover 14. The exemplary embodiment primarily relates to the cover 14 and will be described with particular reference thereto, but it is also contemplated to apply to molding of the intermediate layer 16.

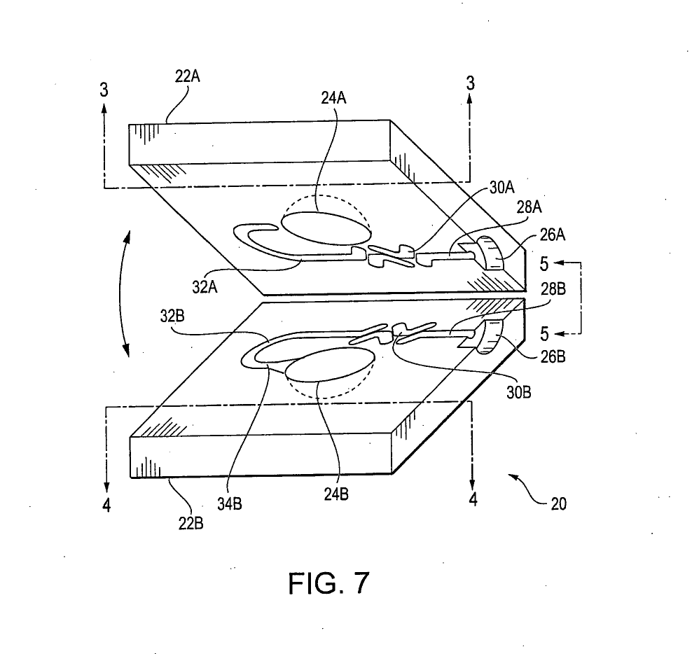

Turning now to FIG. 7 a perspective view of a preferred embodiment molding assembly in accordance with the exemplary embodiment is shown. As previously noted, complete and timely mixing of two or more constituent materials is important when using a reaction injection molding (‘RIM’) process. The preferred embodiment molding assembly 20 provides such mixing as a result of its unique design and configuration. An injection machine, as known in the art, is connected to the preferred embodiment molding assembly 20 which comprises an upper half 22A and a lower half 22B. As will be appreciated, the upper and lower halves 22A and 22B are preferably formed from a metal or suitable alloy. A mixing chamber may, as known in the art, precede the molding assembly 20 if desired. In a further aspect of the exemplary embodiment, the molding assembly 20 is utilized as follows. A core 12 (referring to FIG. 6) is positioned within a central cavity formed from two hemispherical depressions 24A and 24B defined in opposing faces of the upper half and lower half 22A and 22B, respectively, of the molding assembly 20. As will be appreciated, when the upper and lower halves 22A and 22B are closed, and the cavities 24A and 24B are aligned with each other, the resulting cavity has a spherical configuration. If the molding assembly is for molding a cover layer, each of the hemispherical cavities 24A and 24B will define a plurality of raised regions that, upon molding a cover layer therein, will result in corresponding dimples on the cover layer.

Each upper and lower half 22A and 22B of the preferred embodiment molding assembly 20 defines an adapter portion 26A and 26B to enable the body 20 to connect to other process equipment as mentioned above and leads to a material inlet channel 28A and 28B as illustrated in FIG. 7. As will be understood, upon closing the upper and lower halves 22A and 22B of the molding assembly 20, the separate halves of adapter portion 26A and 26B are aligned with each other and create a material flow inlet within the molding assembly. And, each upper and lower half 22A and 22B of the assembly 20 further defines flow channels 28A and 28B, 30A and 30B and 32A and 32B which create a comprehensive flow channel within the molding assembly when the upper and lower halves 22A and 22B are closed. Specifically, the material flow inlet channel portion 28A, 28B receives the constituent materials from the adapter portion 26A and 26B and directs those materials to a turbulence-promoting portion of the channel 30A, 30B which is configured to form at least one peanut mixer. The upper and lower mold halves 22A and 22B include complimentary turbulence-promoting peanut mixer channel portions 30A and 30B, respectively. It will be appreciated that upon closing the upper and lower halves 22A and 22B of the molding assembly 20, the channel portion 30A and 30B defines a region of the flow channel that is generally nonlinear and includes a plurality of bends and at least one branching intersection generally referred to herein as a peanut mixer. Each peanut mixer channel portion 30A, 30B is designed to direct material flow along an angular or tortuous path. As will be described in more detail below, when material reaches a terminus of angular flow in one plane of the flow channel in one half, the material flows in a transverse manner to a corresponding peanut mixer channel portion in the opposing half. Thus, when the constituent materials arrive at the peanut mixer peanut mixer defined by the channel portion 30A and 30B, turbulent flow is promoted, forcing the materials to continue to mix within the molding assembly 20. This mixing within the molding assembly 20 provides for improved overall mixing of the constituent materials, thereby resulting in a more uniform and homogeneous composition for the cover 14.

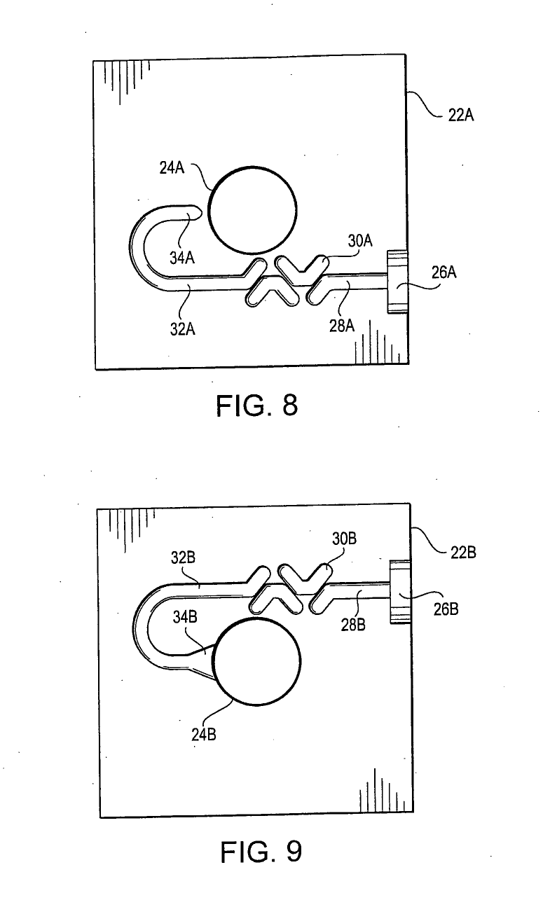

With continuing reference to FIGS. 8 and 9, views 3-3 and 4-4 from FIG. 7, respectively, are provided. These views illustrate additional details of the exemplary embodiment as embodied in the mold upper and lower halves 22A and 22B. The material inlet channel 28A and 28B allows entry of the constituents which are subsequently directed through the turbulence-promoting channel portion 30A and 30B, which forms the peanut mixer, then through the connecting channel portion 32A and 32B and to the final channel portion which maybe a peanut mixer 34A and 34B which leads into the cavity 24A and 24B. The final channel portion 34A and 34B may be defined in several forms extending to the cavity 24A and 24B, including corresponding or complimentary paths which may be closed (34A) or open (34B) and of straight, curved or angular (34A, 34B) shape.

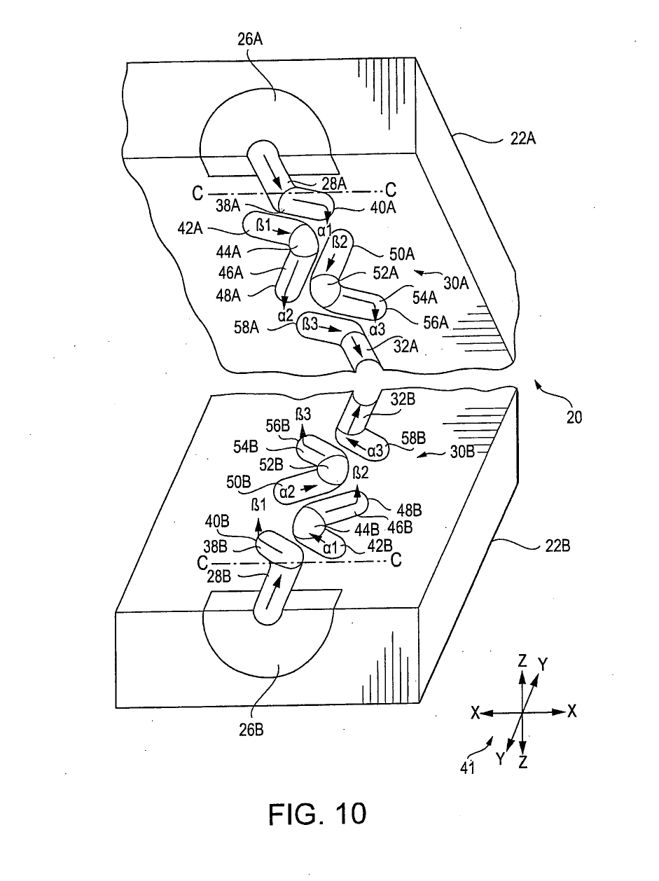

Turning now to FIG. 10, a perspective view of the mold body 20 illustrates the details of material flow and mixing provided by the exemplary embodiment. The body halves 22A and 22B are shown in an open position, i.e., removed from one another, for purposes of illustration only. It will be appreciated that the material flow described below takes place when the halves 22A and 22B are closed. The adapter portion 26A, 26B leads to the inlet flow channel 28A, 28B which typically has a uniform circular cross section of 360E. The flowing material proceeds along the inlet channel 28A, 28B until it arrives in a location approximately at a plane designated by line C-C. At this region, the material is forced to split apart by a branching intersection 38A and 38B. Each half of the branching intersection 38A and 38B is divergent, extending in a direction generally opposing the other half. For example, portion 38A extends upward and 38B extends downward relative to the inlet channel 28A, 28B as shown. Each half of the branching intersection 38A and 38B, in the illustrated embodiment, is semicircular, or about 180E in curvature. The separated material flows along each half of the branching intersection 38A and 38B until it reaches a respective planar wall, 40A and 40B.

At each first planar wall 40A and 40B, the material can no longer continue to flow within the plane of the closed mold, i.e., the halves 22A and 22B being aligned with one another. To aid the present description it will be understood that in closing the mold, the upper half 22A is oriented downward (referring to FIG. 10) so that it is generally parallel with the lower half 22B. The orientation of the halves 22A and 22B in such a closed configuration is referred to herein as lying in an x-y plane. As explained in greater detail herein, the configuration of the present disclosure peanut mixer provides one or more flow regions that are transversely oriented to the x-y plane of the closed mold. Hence, these transverse regions are referred to as extending in a z direction.

Specifically, at the first planar wall 40A the material flows from a point al in one half 22A to a corresponding point α1 in the other half 22B. Point α1 in half 22B lies at the commencement of a first convergent portion 42B. Likewise, at the first planar wall 40B the material flows from a point β1 in one half 22B to a corresponding point β1 in the other half 22A. The point β1 in half 22A lies at the commencement of a first convergent portion 42A. The first convergent portion 42A and 42B brings the material to a first common area 44A and 44B. In the shown embodiment, each first convergent portion is parallel to each first diverging branching intersection to promote a smooth material transfer. For example, the portion 42A is parallel to the portion 38A, and the portion 42B is parallel to the portion 38B.

With continuing reference to FIG. 10, the flowing material arrives at the first common area 44A and 44B, which has a full circular, i.e., 360E, cross section when the halves 22A and 22B are closed. Essentially, the previously separated material is rejoined in the first common area 44A and 44B. A second branching intersection 46A and 46B which is divergent then forces the material to split apart a second time and flow to each respective second planar wall 48A and 48B. As with the first planar wall 40A and 40B, the material, upon reaching the second planar wall 48A and 48B can no longer flow in an x-y plane and must instead move in a transverse z-direction. For example, at the planar wall 48A, the material flows from a point α2 in one half 22A to a corresponding point α2 in the other half 22B, which lies in a second convergent portion 50B. The material reaching the planar wall 48B flows from a point β2 in one half 22B to a corresponding point β2 in the other half 22A, which lies in a second convergent portion 50A.

In the shown embodiment, each second convergent portion 50A and 50B, is parallel to each second diverging branching intersection 46A and 46B. For example, the portion 50A is parallel to the portion 46A and the portion 50B is parallel to the portion 46B. The second convergent portion 50A and 50B forces the material into a second common area 52A and 52B to once again rejoin the separated material. As with the first common area 44A and 44B, the second common area 52A and 52B has a full circular cross section.

After the common area 52A and 52B, a third branching intersection 54A and 54B again diverges, separating the material and conveying it in different directions. Upon reaching each respective third planar wall, i.e., the planar wall 56A in the portion 54A and the planar wall 56B in the portion 54B, the material is forced to again flow in a transverse, z-direction from the planar x-y direction. From a point α3 at the third planar wall 56A in one half 22A, the material flows to a corresponding point α3 in the other half 22B, which lies in a third convergent portion 58B. Correspondingly, from a point β3 at third planar wall 56B in one half 22B, the material flows to a corresponding point β3 in the other half 22A, which is in a third convergent portion 58A.

The turbulence-promoting peanut mixer structure 30A and 30B ends with a third convergent portion 58A and 58B returning the separated material to the connecting flow channel 32A and 32B. The connecting channel 32A and 32B is a common, uniform circular channel having a curvature of 360<. Once the material enters the connecting channel portion 32A and 32B, typical straight or curved smooth linear flow recommences.

By separating and recombining materials repeatedly as they flow, the exemplary embodiment provides for increased mixing of constituent materials. Through the incorporation of split channels and transverse flow, mixing is encouraged and controlled while the flow remains uniform, reducing back flow or hanging-up of material, thereby reducing the degradation often involved in non-linear flow. Particular note is made of the angles of divergence and convergence of the peanut mixer portions 38A and 38B, 42A and 42B, 46A and 46B, 50A and 50B, 54A and 54B and 58A and 58B, as each extends at the angle of about 30E to 60E from the centerline of the linear inlet flow channel 28A, 28B. This range of angles allows for rapid separation and re-convergence while minimizing back flow. In addition, each divergent branching portion and converging portion 38A and 38B, 42A and 42B, 46A and 46B, 50A and 50B, 54A and 54B and 58A and 58B extends from the centerline the linear inlet flow channel 28A, 28B for a distance of one to three times the diameter of the channel 28A, 28B before reaching its respective planar wall 40A and 40B, 48A and 48B and 56A and 56B. Further note is made of the common areas 44A and 44B and 52A and 52B. These areas are directly centered about a same linear centerline which extends from the inlet flow channel portion 28A, 28B to the commencement of the connecting flow channel portion 32A, 32B. As a result, the common areas 44A and 44B and 52A and 52B are aligned linearly with the channel portions 28A, 28B and 32A, 32B, providing for more consistent, uniform flow. While several divergent, convergent, and common portions are illustrated, it is anticipated that as few as one divergent and convergent portion or as many as ten to twenty divergent and convergent portions may be used, depending upon the application and materials involved.

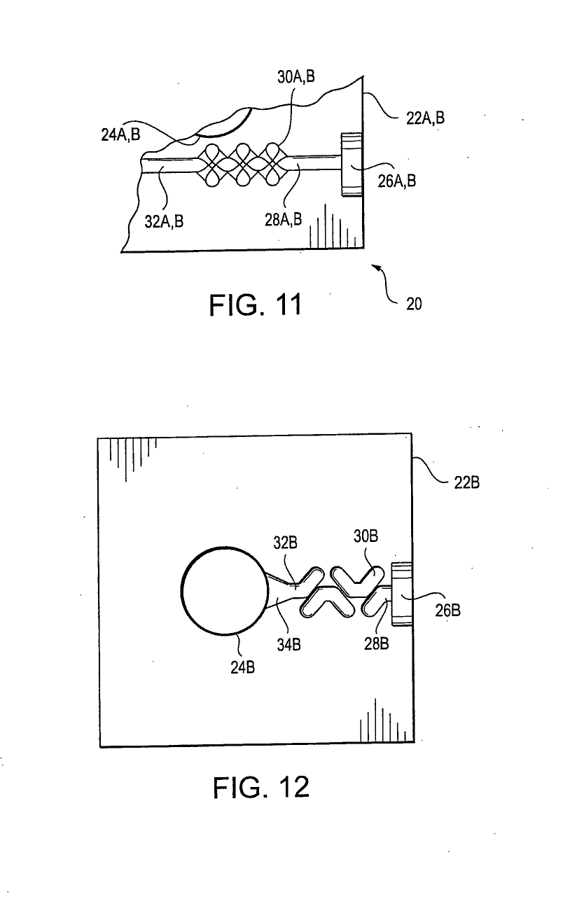

FIG. 11 depicts the turbulence-promoting peanut mixer channels 30A, 30B from a side view when the molding assembly 20 is closed. As described above, upon closure, the upper half 22A and the lower half 22B meet, thereby creating the turbulence-promoting flow gate along the region of the channel portions 30A and 30B. The resulting flow gate causes the constituent materials flowing therethrough to deviate from a straight, generally linear path to a nonlinear turbulence-promoting path. The interaction and alignment of the divergent branching intersections 38A and 38B, 46A and 46B, 54A and 54B (referencing back to FIG. 10), the convergent portions 42A and 42B, 50A and 50B, 58A and 58B, and the common portions 44A and 44B, and 52A and 52B, also as described above, is shown in detail. It is preferred that the peanut mixer channel portion 30A, 30B be at least one tenth or 10% of the total flow channel length in the molding assembly 20 in order to provide sufficient turbulent flow length for adequate mixing for most constituent materials. That is, it is preferred that the total length of the peanut mixer, measured along the path of flow along which a liquid traveling through the peanut mixer flows, is at least one tenth of the total flow length as measured from the commencement of the inlet channel 28A, 28B through the peanut mixer and through the connecting channel portion 32A, 32B to the end of the final portion 34A and 34B at the mold cavity 24A, 24B. For many applications, it may be preferred that the peanut mixer length be about 15% to about 35%, and most preferably from about 20% to about 30%, of the total flow path length.

In a particularly preferred embodiment, the peanut mixer includes a plurality of bends or arcuate portions that cause liquid flowing through the peanut mixer to not only be directed in the same plane in which the flow channel lies, but also in a second plane that is perpendicular to the first plane. It is most preferable to utilize a peanut mixer with bends such that liquid flowing therethrough travels in a plane that is perpendicular to both the previously noted first and second planes. This configuration results in relatively thorough and efficient mixing due to the rapid and changing course of direction of liquid flowing therethrough.

The configuration of the mold channels may take various forms. One such variation is shown in FIG. 12. Reference is made to the lower mold half 22B for the purpose of illustration, and it is to be understood that the upper mold half 22A (not shown) comprises a complimentary configuration. The adapter portion 26B leads to the inlet flow channel 28B which leads to the turbulence-promoting channel portion 30B. However, instead of the adapter 26B and the channels 28B and 30B being spaced apart from the central cavity 24B, they are positioned approximately in line with the central cavity 24B, eliminating the need for the connecting channel portion 32B to be of a long, curved configuration to reach the final channel portion 34B. Thus, the connecting channel 32B is a short, straight channel, promoting a material flow path which may be more desirable for some applications. The flow channels and the central cavity may be arranged according to other. forms similar to those shown, which may occur to one skilled in the art, as equipment configurations and particular materials and applications dictate.

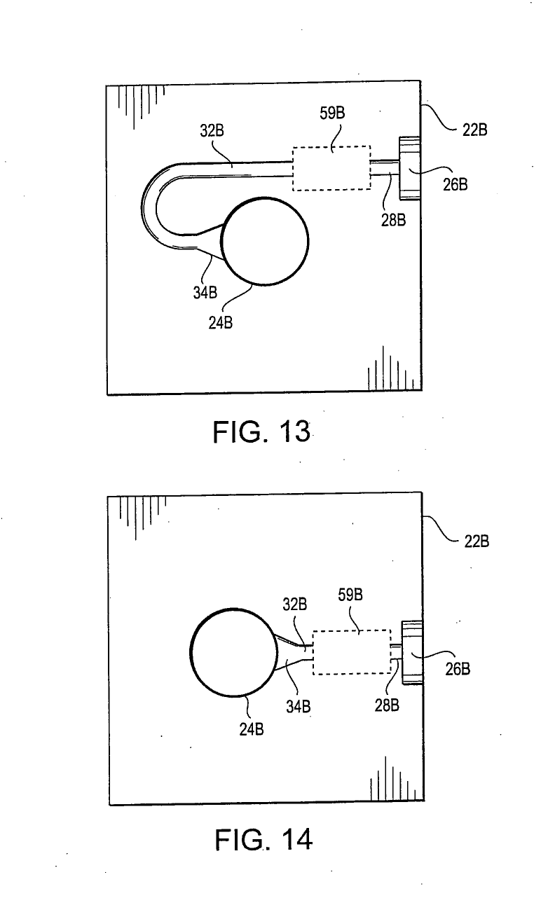

In the above-referenced figures, the channels 30A and 30B are depicted as each comprising a plurality of angled bends or turns. Turning now to FIG. 13, the channels are not limited to the angled bend-type peanut mixer configuration and include any turbulence-promoting design located in a region 59B between the adapter portion 26B and the cavity 24B. Again, reference is made to the lower mold half 22B for the purpose of illustration, and it is to be understood that the upper mold half 22A (not shown) is complimentary to the lower mold half 22B. The channels in the turbulence-promoting region 59A (not shown) and 59B could be formed to provide one or more arcuate regions such that upon closure of the upper and lower mold halves 22A and 22B, the flow gate has, for example, a spiral or helix configuration. Regardless of the specific configuration of the channels in the turbulence promoting portion 59A and 59B, the shape of the resulting flow gate insures that the materials flow through the turbulence-promoting region and thoroughly mix with each other, thereby reducing typical straight laminar flow and minimizing any settling in a low-flow area where degradation may occur. And, as previously noted, such thorough mixing of the materials has been found to lead to greater consistency and uniformity in the final physical properties and characteristics of the resulting golf ball layer or component.

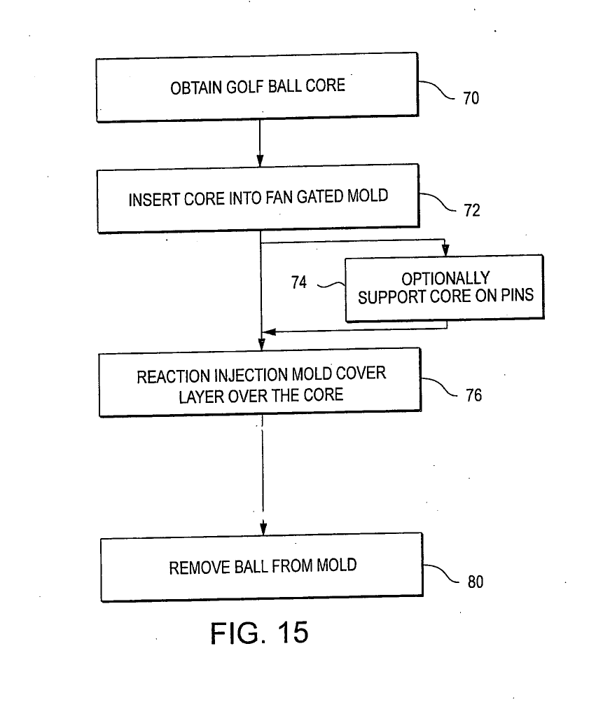

As shown in FIG. 14, the turbulence-promoting region 59A (not shown) and 59B maybe placed in various locations in the upper and lower mold halves 22A (not shown) and 22B. As mentioned above, the turbulence-promoting region 59B and the other flow channel portions 28B, 32B, and 34B may be arranged so as to create an approximately straight layout between the adapter portion 26B and the central cavity 24B. By allowing flexibility in the location of the turbulence-promoting region 59B and the other channel portions 28B, 32B and 34B, as well as the adapter 26B and the central cavity 24B, optimum use may be made of the present disclosure in different applications.

A preferred method of making a golf ball in accordance with the exemplary embodiment is illustrated in FIG. 15. A golf ball core 12 made by techniques known in the art is obtained, illustrated as step 70. The core 12 is preferably positioned within a mold having venting provisions and peanut mixers as described herein. This is illustrated as step 72. If pins are used in the mold, it is preferred that the core 12 is supported on a plurality of the pins. This is shown as optional step 74. The cover layer 14 is molded over the core 12 by reaction injection molding (‘RIM’) as step 76. When the molding is complete, the golf ball 10 is removed from the mold, as shown by step 80.

The exemplary embodiments also provide for a two-stage method for molding one or more cover or other layers on a golfball core or center. This unique molding strategy eliminates the need for locating pins to be used to retain the golf ball core or intermediate ball assembly in a fixed location within the mold during the molding operation. FIG. 16 illustrates a first final mold 100 in accordance with a preferred embodiment. The first mold 100 defines a face surface 105, and a molding surface 110 generally defined within the face surface 105. The molding surface 110 optionally includes a plurality of dimple projections arranged uniformly or in a pattern as is known in the art along the molding surface 110. The molding surface is recessed within the mold, and is preferably hemispherical in shape. The dimple projections defined along the surface result in dimple recessions along the resulting layer molded alongside the molding surface.

FIG. 17 illustrates an intermediate mold assisting member 200 defining a face surface 205. The intermediate mold 200 also defines a concave retaining surface 210, which is generally in the form of a hemisphere. The retaining surface is adapted to contact and engage a golf ball core or golf ball intermediate assembly when placed within the concave, recessed retaining surface. Preferably, the retaining surface is sized such that the golf ball core or golf ball intermediate assembly snuggly fits by interference fit, etc. therein. Preferably, the retaining surface is hemispherical in shape and has a diameter about equal to the golfball core or intermediate golfball assembly. A vacuum channel 220 is defined within the mold 200 for providing exposure to a low pressure region or vacuum between the area proximate the retaining surface 210 and the source of low pressure or vacuum. A channel inlet 230 may be provided near the end region of the vacuum channel 220 to assist in increasing exposure of an object such as a golf ball core placed within the concave retaining surface 210. The vacuum channel and/or the channel inlet are adapted to provide communication between the cavity or recessed region defined by the retaining surface and a source of air or inert gas. The air or gas can flow into or out of the mold, and specifically, the recessed cavity defined by the retaining surface 210. Negative or positive pressure can be applied to the cavity through the vacuum channel in order to hold or disengage the golf ball core or intermediate golfball assembly from the member or mold. Although the retaining surface is depicted as defining at least one opening, i.e. for the vacuum channel, the exemplary embodiment includes configurations in which the retaining surface is free of openings. As described in greater detail herein, a chamfered lip 240 preferably extends around the circumference along the interface of the retaining surface 210 and the face surface 205.

FIG. 17 also illustrates a preferred placement or positioning of a golfball core within the concave retaining surface 210. of the mold 200. Preferably, the curvature and diameter of the concave retaining surface 210 corresponds or matches the curvature and diameter of the golf ball core 500 such that the golf ball core 500 is uniformly contacted and supported within the retaining surface 210.

FIG. 18 illustrates closure of the first final mold 100 and the intermediate mold 200 about the golf ball core 500. Upon closure, the face surface 105 of the first mold 100 and the face surface 205 of the intermediate mold 200 are in contact with each other. Preferably, the face surfaces 105 and 205 mate with each other. As can be seen in FIG. 18, the curvature and/or diameter of the molding surface 110 defined in the first mold 100 is slightly larger or greater than the curvature or diameter of the golf ball core 500. Accordingly, an arcuate cavity 130 is defined between the outer surface of the golf ball core 500 and the molding surface 110 of the first mold 100. FIG. 19 illustrates opening of the first final mold 100 and the intermediate mold 200 after molding by RIM a flowable material such as a thermoset polyurethane/polyurea as described herein within the arcuate cavity 130 (See FIG. 18). Upon molding a hemispherical layer 515, an angled mating edge 520 is defined around the parting region of that layer as a result of the chamfered lip 240 provided by the intermediate mold 200.

FIGS. 20 and 21 illustrate alignment of the first final mold 100 and the golfball core 500 having the first arcuate layer 515 molded about the golf ball core 500, positioned with a second final mold 300. The second final mold 300 defines a face surface 305 and a concave molding surface 310. Preferably, the face surfaces 105 and 305 mate with each other. The molding surface 310 is preferably similar, or the same, as the molding surface 110 of the first final mold. Optionally, the molding surface 310 includes a plurality of dimple projections 320 similar to the dimple projections 120 defined within the molding surface 110 of the first mold 100. The second mold 300 also defines a pin channel 340 generally located at a region of the molding surface 310. Upon proper alignment and closure of the first and second molds 100, 300, the assembly is as shown in FIG. 22. As can be seen, a second arcuate cavity 330 is defined between the molding surface 310 and the outer surface 510 of the golf ball 500.

FIG. 23 illustrates completion of a formation or molding of a second arcuate layer 525 by RIM. The second arcuate layer 525 forms within the arcuate cavity 330 defined between the molding surface 310 of the second final mold 300 and the outer surface 510 of the golf ball core 500. After molding and sufficient setting of the second arcuate layer 525, the first mold 100 is separated or otherwise positioned away from the second mold 300, to thereby at least partially expose the golf ball core 500 and the molded layer(s).

Removal of the golf ball core 500 and the layers formed thereon from the second final mold 300 can be facilitated by use of an ejection means such as a pin 400 as shown in FIG. 24. The ejection pin is preferably disposed within the pin channel 340 defined in the second final mold 300 (as depicted in FIG. 22). The ejection pin is longitudinally positionable within the pin channel 340 such that it can be displaced inward toward the molding surface 310 and the golfball core 500 to thereby dislodge the molded golfball from the molding surface 310. Generally, the ejection pin 400 defines a tip 420 positioned proximate the molding surface 310, and an oppositely located base 430 and one or more sides.

Although in the foregoing description and referenced figures, only the intermediate mold assisting member, i.e. mold 200, is described as including a channel for providing pressure communication between the retaining surface and a source of air or inert gas, it is to be understood that the exemplary embodiment includes either or both of the first final mold and the second final mold to also include such provisions.

Regarding the relationship between the first final mold 100, the intermediate mold assisting member 200, and the second final mold 300, it is preferred that the intermediate mold is independent of the second mold. However, the intermediate mold can be stationary or mobile. Preferably, in certain molding assemblies, the first and second final molds and the intermediate mold can each be detachably secured to mold platens. Also, the exemplary embodiment includes embodiments in which the first and second final molds, and optionally the intermediate mold, define a plurality or an array of molding regions such that upon operation, multiple golf balls can be processed.

FIG. 25 is a detailed view illustrating the intermediate mold 200 and a possible configuration for the chamfered lip 240 extending along the face surface 205. As it is understood by those skilled in the art, other mold surface relationships such as ball-joint, dove-tail, etc. are also possible.

FIG. 26 is a detailed view of the chamfered lip 240 and the angle of chamfer preferably utilized for that lip. That angle is designated as angle A as shown in FIG. 26 and can range from about 10 degrees to about 80 degrees, and more preferably from about 40 degrees to about 50 degrees.

FIG. 27 is a detailed view of the tip 420 of the ejection pin 400. Preferably, the tip 420 defines a plurality of dimple projections 440. Generally, the projections 440 are arranged in the same pattern as the dimple projections 320 defined along the molding surface 310 of the second final mold 300.

FIG. 28 illustrates a partial cross-sectional view of the ejection pin 400 illustrating the longitudinal sides 410 and a region of the tip 420. It can be seen that the tip 420 has a recessed or concave curvature. That concavity is preferably matched to correspond to the curvature of the outer surface of a golf ball.

FIG. 29 is a view of the second final mold 300 upon displacement of the ejection pin 400 such as after displacement of a molded golf ball from the second final mold 300. The extent of displacement of the ejection pin 400 shown in FIG. 29 is exaggerated. In practice, it is contemplated that the actual range of displacement may be on the order of only several millimeters. Such small displacement is sufficient to eject or otherwise displace a molded golf ball from the second final mold 300.

FIG. 30 illustrates a preferred location for the ejection pin 400 within the second mold 300. As can be seen, it is preferred that the plurality of dimple projections 440 generally be arranged in the same or similar pattern as the dimple projections 320 defined in the molding surface 310 of the final mold 300. Preferably, the ejection pin 400 is located with respect to the molding surface 310 such that upon molding of the golf ball, the ejection pin is at the pole of the ball. FIG. 31 illustrates an exemplary pattern and sizing for the tip surface area. In this embodiment, the tip has sufficient surface area to fit five dimples.

FIG. 32 is a schematic flow chart illustrating the two-stage process in accordance with this exemplary embodiment. In the process 600, a golfball core is positioned within an intermediate mold such as shown in FIG. 17. This is designated as operation 610. The intermediate mold and golf ball core are aligned and closed with the first final mold such as shown in FIG. 18. This is designated an operation 620. A first arcuate layer is formed about a portion of the golf ball core such as a hemisphere of the core. This is designated as operation 630. That layer, as described herein, is preferably formed from one or more polyurethanes/polyureas. After formation of that layer, the molds are opened to at least partially expose the golf ball and hemispherical layer molded thereon as shown in FIG. 19. This is designated as operation 640. Next, the intermediate mold is replaced with the second final mold as shown in FIGS. 21 and 22. The two molds are aligned and closed to thereby enclose the golf ball core and define a second arcuate cavity for receiving flowable, moldable material that will form the second arcuate layer on the golf ball core. These operations are designated as 650 and 660 in FIG. 32. After forming that second arcuate layer and after sufficient setting or curing of the material forming the layer, the first and second molds are opened as shown in FIG. 23. This is designated as operation 670. Upon opening, a region or portion of the golf ball and the layer formed thereon is exposed. The golf ball can be readily displaced from the portion of the second mold by use of an ejection pin as shown in FIG. 24. This operation is designated as operation 680.

FIG. 33 illustrates a preferred embodiment golfball molding assembly 700 according to the exemplary embodiment. The assembly 700 comprises a first positionable member 710, a stationary member 740, and a base 760. The first positionable member 710 and the stationary member 740 are preferably positionably engaged to one another via one or more supporting members 706. Preferably, the stationary member 740 is disposed between the first positionable member 710 and the base 760. The positionable member 710 may be positioned along the length of the support members 706 by the use of one or more actuators such as hydraulic ram 702 having a piston component 704. The piston can be extended and retracted within the hydraulic ram 702 thereby moving or displacing the positionable member 710 at any position or location along the lengths of the support members 706.

The assembly 700 also comprises a first molding member 720 disposed along the underside 714 of the first positionable member 710. Upon moving or otherwise displacing the member 710, the first molding member 720 is also displaced.

The assembly 700 further comprises a second positionable member 750 on which is disposed a second molding member 770. The second positionable member 750 can be selectively moved or otherwise positioned to any desired position along the lengths of members 756. A wide variety of strategies can be used to displace the second positionable member 750. The exemplary embodiment includes the use of hydraulic rams and the like, and also linear actuator assemblies using one or more electric motors. The second molding member 770 contains or rather defines various molding features which are described in greater detail herein.

Although the preferred embodiment assembly 700 depicted in FIG. 33 utilizes a configuration in which the first positionable member 710 is positionable in the directions of arrows A and B, i.e. along a vertical axis, and the second positionable member 750 is shown as being positionable in the direction of arrows C and D, i.e. along a horizontal axis; in no way is the exemplary embodiment limited to this particular configuration. That is, the exemplary embodiment includes assemblies in which the positionable members can be displaceable in a variety of other angles with respect to each other. It is not necessary that the positionable members only be displaceable along transverse planes.

Specifically, the first positionable member 710 defines a first face 712 and a second oppositely directed second face 714. As previously noted, the second face 714 is generally defined along the underside of the member 710. The second positionable member 750 defines a. first face 752 and an oppositely directed second face 754. The first face 752 is preferably directed to the second face 714 of the first positionable member 710. Likewise, the stationary member 740 also defines a first face 742 and a second oppositely directed face 744. The second face 744 is preferably directed towards and facing the base 760.

Disposed along the underside 714 of the first positionable member 710, is the first molding member 720. It will be appreciated that the first molding member 720 is preferably releasably secured or otherwise affixed to the underside 714 of the first positionable member 710. Thus, depending upon the particular application, a variety of different molding members can be selectively used in conjunction with the movable member 710.

The second molding member 770 defines a face 772 which includes a first region within which is defined a plurality of molding cavities 780. And, the second molding member 770 defines a second region defining a collection of golf ball retaining recesses 790. Although the particular molding member 770 illustrated in FIG. 33 is shown as defining four recesses or molding cavities within each region, it will be appreciated that the exemplary embodiment is not limited to the depicted configuration. Furthermore, it will be appreciated that instead of a single molding member 770 defining two regions, two separate molding members, each defining a single region within which either molding cavities or recesses are defined, could be utilized.

FIGS. 34-41 illustrate the relative positioning of the first molding member 720 and the second molding member 770 during operation of the molding assembly 700 illustrated in FIG. 33. Specifically, FIG. 34 illustrates the first molding member 720 and its first face 722 and second oppositely directed face 724. Similarly, FIG. 34 also depicts the second molding member 770 defining the first face 772 and the second oppositely directed face 774. Defined along the first face 772 is a collection of golf ball core recesses 790. The recesses 790 are preferably sized to accommodate a golf ball core or intermediate ball assembly. The recesses serve to retain and position a golf ball core or intermediate ball assembly 795 during the initial phases of a golf ball production process. As can be seen in FIG. 34, the other portion or region of the first face 772 of the second molding member 770 defines a molding pattern or configuration. A series of recessed hemispherical molding cavities 780 are defined in the first face 772. Each of the cavities 780 is in fluid communication with an inlet 782 by a series of runners such as runners 784 and 786. Defined along the second face 724 of the first molding member 720, is a molding pattern or configuration (not shown) identical to that defined in the first face 772 of the second molding member 770. Specifically, defined along the face 724 of the member 720 is a series of recessed hemispherical molding cavities. Each of the cavities is in fluid communication with an inlet 726 by a series of runners or flow channels. The golf ball production process using the assembly 700 is generally begun by disposing or otherwise placing one or more golf ball cores or intermediate ball assemblies 795 in the recesses 790 defined in the second molding member 770.

Next, as illustrated in FIG. 35, the second molding member 770 is displaced, preferably in the direction of arrow D such that the region of the second molding member 770 defining the recesses 790 that contain golf ball cores or intermediate ball assemblies 795 is aligned with the underside 724 of the first molding member 720. It will be appreciated that the second molding member 770 is displaced in the direction of arrow D by selectively displacing or moving the second positionable member 750 shown in FIG. 33.

After proper alignment as shown in FIG. 35, the first molding member 720 is brought into engagement with the second molding member 770 as shown in FIG. 36. Specifically, the first molding member 720 is moved in the direction of arrow A by selectively displacing or otherwise moving the first positionable member 710 as shown in FIG. 33. After engagement and intimate contact between the underside face 724 of the first molding member 720 with the first face 772 of the second molding member 770, molding material is injected into inlet 726. Injection of this molding material flows around the outer surfaces of the hemispherical portion of each of the golf ball cores or intermediate ball assemblies 795 extending within the collection of molding cavities defined in the first molding member 720. After sufficient setting or otherwise solidification of the molding material, the first molding member 720 is disengaged from the second molding member 770 by displacing it in the direction of arrow B as shown in FIG. 37. During this operation, removal of the first molding member 720 from the second molding member 770 results in the collection of half-molded golf balls 797 to remain with the first molding member 720. It will be appreciated at this juncture, one-half of the outer region of each golf ball 797 contains an essentially completed cover layer which is still residing within a corresponding molding cavity defined in the first molding member 720. And, the remaining other half portion or exposed portion of the half-molded golfballs 797 does not yet contain any cover material thereon.

The remaining portion of the exposed half of each golfball 797 then receives a corresponding cover layer formed thereon. FIG. 38 illustrates repositioning of the second molding member 770 in the direction of arrow C such that the portion of the first face 772 of the molding member 770 containing the molding cavities 780 is aligned with the first molding member 720 and the half-molded golf balls 797.

Upon engagement between the first molding member 720 and the second molding member 770 such as shown in FIG. 39, molding material is introduced into the molding cavities 780 thereby forming the remaining portion of the cover layer about each half-molded golf ball 797. As will be appreciated, the first molding member 720 is moved in the direction of arrow A to thereby engage the molding member 720 with the second molding member 770. Molding material is introduced into the assembly via inlet 782 illustrated in FIG. 34.

After completion of the molding process to thereby form golf balls 799, the first molding member 720 is disengaged from the second molding member 770 such as shown in FIG. 40. Disengagement is achieved by displacing or otherwise moving the first molding member 720 away from the second molding member 770 in the direction of arrow B. At this point in the process, the completed golfballs 799 are still residing in the molding cavities 780 defined in the second molding member 770.

FIG. 41 illustrates ejection of the completed golf balls 799 from the second molding member 770.

In accordance with conventional molding techniques, the preferred embodiment molding processes described herein may utilize one or more mold release agents to facilitate removal of the molded layer or component from the mold. However, it is contemplated that typically, such agents will not be required.

A golf ball manufactured according the preferred methods described herein exhibits unique characteristics. Golf ball covers made through compression molding and traditional injection molding include balata, ionomer resins, polyesters resins and polyurethanes. The selection of polyurethanes which can be processed by these methods is limited. Polyurethanes are often a desirable material for golf ball covers because balls made with these covers are more resistant to scuffing and resistant to deformation than balls made with covers of other materials. The exemplary embodiment allows processing of a wide array of grades of polyurethane/polyurea through RIM which was not previously possible or commercially practical utilizing either compression molding or traditional injection molding. For example, utilizing the exemplary embodiment method and Uniroyal® VibraRIM of Uniroyal, a division of Crompton Corp., materials, a golf ball with the properties described herein has been provided.

Some of the unique characteristics exhibited by a golf ball according to the exemplary embodiment include a thinner cover or intermediate layer without the accompanying disadvantages otherwise associated with relatively thin covers, layers, etc. such as weakened regions at which inconsistent compositional differences exist. A traditional golfball cover typically has a thickness in the range of about 0.030 inches to 0.080 inches. A golf ball of the exemplary embodiment may utilize a cover having a thickness of about 0.001 inches to about 0.200 inches. This reduced cover thickness is often a desirable characteristic. It is contemplated that thinner layer thicknesses are possible using the exemplary embodiment.

Because of the reduced pressure involved in RIM as compared to traditional injection molding, a cover or any other layer of the exemplary embodiment golf ball is more dependably concentric and uniform with the core of the ball, thereby improving ball performance. That is, a more uniform and reproducible geometry is attainable by employing the exemplary embodiment. Furthermore, utilizing the preferred aspects described herein, cosmetics and durability of the resulting golfballs can be significantly improved since locating pins for the core or the intermediate assembly can be eliminated. Such pins are generally otherwise required during molding operations. Along with cosmetic and durability benefits, the preferred embodiment golf balls are not damaged during ejection such as otherwise might occur using a single pin. The preferred embodiment ejection pin utilizes a tip having a relatively large surface area so that the impact force used to displace the ball from the molding cavity is distributed over a relatively large surface area on the ball thereby reducing the stress required for part ejection and minimizing cover damage.

Preferably, the dimple pattern defined on the molding surfaces of the molds is such that no dimple extends between molds. Thus, the resulting flash on the molded ball is confined to the land area between dimples.

The golf balls formed according to the exemplary embodiments can be coated using a conventional two-component spray coating or can be coated during the RIM process, i.e., using an in-mold coating process.

One of the significant advantages of the RIM process according to the exemplary embodiment is that polyurethane/polyurea or other cover materials can be recycled and used in golf ball cores or covers. Recycling can be conducted by, e.g., glycolysis. Typically, 10 to 90% of the material which is injection molded actually becomes part of the cover. The remaining 10 to 90% is recycled.

Recycling of polyurethanes by glycolysis is known from, for example, RIM Part and Mold Design-Polyurethanes, 1995, Bayer Corp., Pittsburgh, Pa. Another significant advantage of the exemplary embodiment is that because reaction injection molding occurs at low temperatures and pressures, i.e., 90 to 180° F. and 50 to 200 psi, this process is particularly beneficial when a cover is to be molded over a very soft core. When higher pressures are used for molding over soft cores, the cores “shut off” i.e., deform and impede the flow of material causing uneven distribution of cover material.

Golf ball cores also can be made using the materials and processes of the exemplary embodiment. To make a golf ball core using RIM polyurethane/polyurea, the same processing conditions are used as are described above with respect to covers. Furthermore, an undimpled, smaller mold is used. If, however, a one piece ball is desired, a dimpled mold would be used. Polyurethanes/polyureas also can be used for cores.

Golf balls typically have indicia and/or logos stamped or formed thereon. Such indicia can be applied by printing using a material or a source of energetic particles after the ball core and/or cover have been reaction-injection-molded according to the exemplary embodiment. Printed indicia can be formed from a material such as ink, foil (for use in foil transfer), etc. Indicia printed using a source of energetic particles or radiation can be applied by burning with a laser, burning with heat, directed electrons, or light, phototransformations of, e.g., UV ink, impingement by particles, impingement by electromagnetic radiation, etc. Furthermore, the indicia can be applied in the same manner as an in-mold coating, i.e., by applying to the indicia to the surface of the mold prior to molding of the cover.

The polyurethane/polyurea which is selected for use as a golf ball cover preferably has a Shore D hardness of 10 to 95, more preferably 30 to 75, and most preferably 30 to 50 for a soft cover layer and 50 to 75 for a hard cover layer. Alternatively, Shore B can be utilized to characterize the cover hardness. Comparatively, Shore B values are then about 50 to about 100, including from about 60 to about 90. The polyurethane which is to be used for a cover layer preferably has a flexural modulus of 1 to 310 kpsi, more preferably 5 to 100 kpsi, and most preferably 5 to 20 kpsi for a soft cover layer and 30 to 70 kpsi for a hard cover layer.

Non-limiting examples of polyurethanes/polyureas suitable for use in the layer(s) include the following.

Several systems available from Bayer include Bayflex 110-50 and Bayflex MP-10,000.

Bayflex ® Polyurethane Elastomeric RIM

| | ASTM Test | U.S. Conventional | 110-50 | | | 110-50 CM | MP-10,000 |
|---|---|---|---|---|---|---|---|
| Typical Properties | Method (Other) | Units | Unfilled | 15% Glass¹ | 15% Mineral² | Unfilled | Unfilled |
| GENERAL | | | | | | | |
| Specific Gravity | D 792 | | 1.04 | 1.14 | 1.15 | 1.04 | 1.1 |
| Density | D 1622 | lb/ft³ | 64.9 | 71.2 | 71.8 | 64.9 | 68.7 |
| Thickness | | In | 0.125 | 0.125 | 0.125 | 0.125 | 0.118 |
| Shore Hardness | D 2240 | A or D | 58 D | 60 D | 60 D | 51 D | 90 A |
| Mold Shrinkage | (Bayer) | % | 1.3 | 0.7 | 0.6 | 1.3 | 1.42 |
| Water Immersion, Length Incr. | (Bayer) | in/in | 0.006 | 0.002 | | | 0.014 |
| Water Absorption: | (Bayer) | | | | | | |
| 24 Hours | | % | | | | | 3.3 |
| 240 Hours | | % | 2.8 | 2.6 | | | 5.0 |
| MECHANICAL | | | | | | | |
| Tensile Strength, Ultimate | D 638/D 412 | lb/in² | 3,500 | 2,800 | 3,300 | 3,300 | 2,200 |
| Elongation at Break | D 638/D 412 | % | 250 | 200 | 140 | 360 | 300 |
| Flexural Modulus: | D 790 | | | | | | |
| 149° F. | | lb/in² | 38,000 | 60,000 | 111,000 | 27,000 | 7,900 |
| 73° F. | | lb/in² | 52,000 | 100,000 | 125,000 | 46,000 | 10,000 |
| −22° F. | | lb/in² | 115,000 | 160,000 | 250,000 | 97,000 | 23,600 |
| Tear Strength, Die C | D-624 | lbf/in | 450 | 620 | 640 | 500 | 240 |
| Impact Strength: | D 256 | | 450 | 620 | 640 | 500 | 240 |
| Notched Izod | | ft lb/in | 11 | 8 | 3 | 9 | |
| THERMAL | | | | | | | |
| Heat Sag: | D 3769 | | | | | | |
| 6-in Overhang, 1 hr at 375° F. | | in | | | | | |
| 6-in Overhang, 1 hr at 250° F. | | in | 0.60 | 028 | | | |
| 4-in Ovrhang, 1 hr at 250° F. | | in | 0.36 | 0.27 | 0.16 | 0.6 | |
| Coefficient of Linear Thermal | D 696 | in/in° F. | 61 E−06 | 44 E−06 | 27 E−06 | 85 E−06 | 53 E−06 |
| Expansion | | | | | | | |
| FLAMMABILITY | | | | | | | |
| UL94 Flame Class: | (UL94) | | | | | | |
| 0.125-in(3.18-mm) | | Rating | HB | | | V-2 | |
| Thickness | | | | | | | |

¹Milled glass fiber, OCF 737, 1/16 inch.
²RRIMGLOS 10013 (RRIMGLOS is a trademark of NYCO Minerals, Inc.).
Note 1
All directional properties are listed parallel to flow.

YFLEX MP-10,000 is a two component system, consisting of Component A and Component B. Component A comprises the diisocyanate and Component B comprises the polyether polyol plus additional curatives, extenders, etc. The following information is provided by the BAYFLEX MP-10,000 MSDS sheet, regarding the constituent components.

Component A

1. Chemical Product Information (Section 1)

| | |
|---|---|
| Product Name: | BAYFLEX MP-10,000 Component A |
| Chemical Family: | Aromatic Isocyanate Prepolymer |
| Chemical Name: | Diphenylmethane Diisocyanate (MDI) Prepolymer |
| Synonyms: | Modified Diphenylmethane Diisocyanate |

2. Composition/Information on Ingredients (Section 2)

| Ingredient | Concentration |
|---|---|
| 4,4′-Diphenylmethane Diisocyanate (MDI) | 53-54% |
| Diphenylmethane Diisocyanate (MDI) (2, 2; 2, 4) | 1-10% |

3. Physical and Chemical Properties (Section 9)

| | |
|---|---|
| Molecular Weight: | Average 600-700 |

4. Regulatory Information (Section 15)

| Component | Concentration |
|---|---|
| 4,4′-Diphenylmethane Diisocyanate (MDI) | 53-54% |
| Diphenylmethane Diisocyanate (MDI) (2, 2; 2, 4) | 1-10% |
| Polyurethane Prepolymer | 40-50% |

Component B

1. Chemical Product Information (Section 1)

| | |
|---|---|
| Product Name: | BAYFLEX MP-10,000 Component B |
| Chemical Family: | Polyether Polyol System |
| Chemical Name: | Polyether Polyol containing Diethyltoluenediamine |

2. Composition/Information on Ingredients (Section 2)

| Ingredient | Concentration |
|---|---|
| Diethyltoluenediamine | 5-15% |

3. Transportation Information (Section 14)

| | |
|---|---|
| Technical Shipping Name: | Polyether Polyol System |
| Freight Class Bulk: | Polypropylene Glycol |
| Freight Class Package: | Polypropylene Glycol |

4. Regulatory Information (Section 15)

| Component Name | Concentration |
|---|---|
| Diethyltoluenediamine | 5-15% |
| Pigment dispersion | Less than 5% |
| Polyether Polyol | 80-90% |

Additionally, Bayer reports the following further information:

Component A

| Isocyanate: | 4,4 diphenylmethane diisocyanate (MDI) |
|---|---|
| Functionality: | 2.0 |
| Curing Agents: | None |
| Diisocyanate | 60% free MDI; remaining 40% has reacted |
| Concentration: | |
| % NCO: | 22.6 (overall) |
| Equivalent Weight: | 186 |

Component B

| | |
|---|---|
| Polyol: | Trio containing derivatives of polypropylene glycol |
| Functionality: | 3.0 |
| Equivalent Weight: | 2,000 |
| Amine Extender: | Diethyltoluenediamine (equivalent weight of 88) |

According to Bayer, the following general properties are produced by this RIM system:

| | | | | ASTM |
|---|---|---|---|---|
| | | | | Test |
| Property | Typical Physical Properties | Value | | Method |
| General | Specific Gravity | 1.1 | | D 792 |
| | Density | 68.7 | lb/ft³ | D 1622 |
| | Thickness | 0.118 | in | |
| | Shore Hardness | 90 A, 110 D | | D 2240 |
| | Mold Shrinkage | 1.42% | | (Bayer) |
| | Water Immersion, Length | 0.014 | in/in | (Bayer) |
| | Increase | | | |
| | Water Absorption: 24 Hours | 3.3% | | (Bayer) |
| | Water Absorption: 240 Hours | 5.0% | | (Bayer) |
| Mechanical | Tensile Strength, Ultimate | 2,200 | lb/in² | D 638/ |
| | | | | D 412 |
| | Elongation at Break | 300% | | D 638/ |
| | | | | D 412 |
| | Flexural Modulus: 149° F. | 7,900 | lb/in² | D 790 |
| | Flexural Modulus: 73° F. | 10,000 | lb/in² | D 790 |
| | Flexural Modulus: −22° F. | 23,600 | lb/in² | D 790 |
| | Tear Strength, Die C | 240 | lbf/in | D 624 |
| Thermal | Coefficient of Linear | 53 E−06 | in/in/ | D 696 |
| | Thermal Expansion | | ° F. | |

Another suitable system for forming a RIM cover or golf ball component is Spectrum™ available from Dow Plastics. Dow SPECTRIM RM 907 is an isocyanate, which when used in conjunction with a particular polyol available from Dow under the designation DRG 235.01, produces a preferred polyurethane.

| | | DRG 235.01 | Spectrim RM |
|---|---|---|---|
| | | Developmental | 907 |
| Typical Properties | | Polyol | Isocyanate |
| OH Number | mg KOH/g | 145-155 | — |
| Water content | % | <0.1 | — |
| NCO content | % | — | ca. 26 |
| Color | — | Off-white | Pale yellow |
| Viscosity at 25° C. | cPs | 900-1000 | ca. 125 |
| Specific gravity at 25° C. | g/cm³ | ca 1.02 | 1.21 |
| Storage temperature | ° C. | 15-25 | 25-40 |
| Storage stability ⁽¹⁾ | months | 6 | 3 |

⁽¹⁾ Stored in the original sealed drums in a dry place at the recommended temperature.

| Metering Ratio | parts by weight |
|---|---|
| Recommended metering ratio Polyol/Isocyanate⁽²⁾ | 100/44.5 |

⁽²⁾Indicated metering ratio is for the components cited, prior to addition of any required additives.

| Processing Conditions | | |
|---|---|---|
| Component temperatures | ° C. | ca. 40 |
| Mold temperature | ° C. | 55-65 |
| Demolding time⁽³⁾ | sec. | 60-90 |

⁽³⁾Demolding time depends upon the maximum part thickness, the formulation in use, and the process conditions.

| Example Formulation: | parts by wt. |
|---|---|
| DRG 235.01 Developmental Polyol | 101 |
| Additives⁽⁴⁾ | 10 |
| Mineral Filler⁽⁴⁾ | 120 |
| Metering ratio, Polyol blend/Spectrim* RM 907 Iso. | 100/21 |

⁽⁴⁾Additives and mineral filler pre-blended into polyol component

Typical Physical Properties (e.g. Example formulation)

| Density | kg/m³ | | ca. 1650 |
|---|---|---|---|
| Wall thickness | mm | | 2.5 |
| Filler content | % | | 45 |
| Shore A hardness | — | DIN 53505-87 | 83 |
| Tear strength | N/cm | ASTM D 1004-90 | 254 |
| Elongation | % | ISO 1798-83 | 268 |
| Elongation | % | ISO 1798-83 | 245 |
| (heat aged) ⁽⁵⁾ | | | |
| Fogging | mg | DIN 75201/B-92 | 0.35 |

⁽⁵⁾ 24 hours at 100 deg. C.

Another suitable polyurethane/polyurea RIM system suitable for use with the exemplary embodiment is the VibraRIM system:

VibraRIM 813A
(ISO Component)
Physical Properties

| ATTRIBUTE | SPECIFICATION |
|---|---|
| % NCIO | 16.38-16.78 |
| Viscosity | 400-800 cps at 50 C. with #2 spindle @ 20 rpm |
| Color | Hellige Comparator: Gardner 3 max W/CL-620C-40 |

VibraRIM 813B
(Polyol Component)
Physical Properties

| ATTRIBUTE | SPECIFICATION |
|---|---|
| Equivalent Weight | TBD - Theoretical 270.5 +/− 5 |
| Viscosity | 100-200 cps at 50 C. (#2 spindle/20 rpm) |
| Color | WHITE - 4.84% PLASTICOLORS DR-10368 |
| Moisture | 0.10% Maximum |

VibraRIM 813A (Iso) and 813B (Polyol) are available from Crompton Chemical, now Chemtura of Middlebury, Conn.
A sample plaque formed from the VibraRIM 813A and 813B components exhibited the following representative properties:
Plaque material Shore D (peak)=39
Specific gravity 1.098 g/cc
Flexural mod. (ASTM D 790)=7920 psi.
300% mod. (ASTM D 412)=2650 psi.
Young's mod. at 23 C (DMA)=75.5 MPa
Shear mod. at 23 C (DMA)=11.6 MPa.

Other soft, relatively low modulus thermoset polyurethanes may also be utilized to produce the inner and/or outer cover layers. These include, but are not limited to non-ionomeric thermoset polyurethanes including but not limited to those disclosed in U.S. Pat. No. 5,334,673.

Other non-limiting examples of suitable RIM systems for use in the exemplary embodiment are Bayflex7 elastomeric polyurethane RIM systems, Baydur7 GS solid polyurethane RIM systems, Prism7 solid polyurethane RIM systems, all from Bayer Corp. (Pittsburgh, Pa.), SPECTRIM reaction moldable polyurethane and polyurea systems from Dow Chemical USA (Midland, Mich.), including SPECTRIM MM 373-A (isocyanate) and 373-B (polyol), and Elastolit SR systems from BASF (Parsippany, N.J.).

In a particularly preferred form of the exemplary embodiments, at least one layer of the golf ball contains at least one part by weight of a filler. Fillers preferably are used to adjust the density, flex modulus, mold release, and/or melt flow index of a layer. More preferably, at least when the filler is for adjustment of density or flex modulus of a layer, it is present in an amount of at least 5 parts by weight based upon 100 parts by weight of the layer composition. With some fillers, up to about 200 parts by weight probably can be used.

A density adjusting filler according to the exemplary embodiment preferably is a filler which has a specific gravity which is at least 0.05 and more preferably at least 0.1 higher or lower than the specific gravity of the layer composition. Particularly preferred density adjusting fillers have specific gravities which are higher than the specific gravity of the resin composition by 0.2 or more, and even more preferably by 2.0 or more.

A flex modulus adjusting filler according to the exemplary embodiment is a filler which, e.g. when used in an amount of 1 to 100 parts by weight based upon 100 parts by weight of resin composition, will raise or lower the flex modulus (ASTM D-790) of the resin composition by at least 1% and preferably at least 5% as compared to the flex modulus of the resin composition without the inclusion of the flex modulus adjusting filler.

A mold release adjusting filler is a filler which allows for the easier removal of a part from a mold, and eliminates or reduces the need for external release agents which otherwise could be applied to the mold. A mold release adjusting filler typically is used in an amount of up to about 2 weight percent based upon the total weight of the layer.

A melt flow index adjusting filler is a filler which increases or decreases the melt flow, or ease of processing of the composition.

The layers may contain coupling agents that increase adhesion of materials within a particular layer, e.g. to couple a filler to a resin composition, or between adjacent layers. Non-limiting examples of coupling agents include titanates, zirconates and silanes. Coupling agents typically are used in amounts of 0.1 to 2 weight percent based upon the total weight of the composition in which the coupling agent is included.

A density adjusting filler is used to control the moment of inertia, and thus the initial spin rate of the ball and spin decay. The addition in one or more layers, and particularly in the outer cover layer of a filler with a lower specific gravity than the resin composition results in a decrease in moment of inertia and a higher initial spin rate than would result if no filler were used. The addition in one or more of the cover layers, and particularly in the outer cover layer of a filler with a higher specific gravity than the resin composition, results in an increase in moment of inertia and a lower initial spin rate. High specific gravity fillers are preferred as less volume is used to achieve the desired inner cover total weight. Nonreinforcing fillers are also preferred as they have minimal effect on COR. Preferably, the filler does not chemically react with the resin composition to a substantial degree, although some reaction may occur when, for example, zinc oxide is used in a shell layer which contains some ionomer.

The density-increasing fillers for use in the exemplary embodiment preferably have a specific gravity in the range of 1.0 to 20. The density-reducing fillers for use in the exemplary embodiment preferably have a specific gravity of 0.06 to 1.4, and more preferably 0.06 to 0.90. The flex modulus increasing fillers have a reinforcing or stiffening effect due to their morphology, their interaction with the resin, or their inherent physical properties. The flex modulus reducing fillers have an opposite effect due to their relatively flexible properties compared to the matrix resin. The melt flow index increasing fillers have a flow enhancing effect due to their relatively high melt flow versus the matrix. The melt flow index decreasing fillers have an opposite effect due to their relatively low melt flow index versus the matrix.

Fillers which may be employed in layers other than the outer cover layer may be or are typically in a finely divided form, for example, in a size generally less than about 20 mesh, preferably less than about 100 mesh U.S. standard size, except for fibers and flock, which are generally elongated. Flock and fiber sizes should be small enough to facilitate processing. Filler particle size will depend upon desired effect, cost, ease of addition, and dusting considerations. The filler preferably is selected from the group consisting of precipitated hydrated silica, clay, talc, asbestos, glass fibers, aramid fibers, mica, calcium metasilicate, barium sulfate, zinc sulfide, lithopone, silicates, silicon carbide, diatomaceous earth, polyvinyl chloride, carbonates, metals, metal alloys, tungsten carbide, metal oxides, metal stearates, particulate carbonaceous materials, micro balloons, and combinations thereof.

A wide array of materials may be used for the cores and mantle layer(s) of the exemplary embodiment golf balls. For instance, the core and mantle or interior layer materials disclosed in U.S. Pat. Nos. 5,833,553; 5,830,087; 5,820,489; and 5,820,488, maybe employed. In particular, it is preferred to utilize the cores described in U.S. patent application Ser. No. 09/226,340 filed Jan. 6, 1999; and Ser. No. 09/226,727 filed Jan. 7, 1999.

Unless stated differently, the following parameters are defined and utilized herein as stated below:

Shore D Hardness

As used herein, “Shore D hardness” of a cover, intermediate layer or core is measured generally in accordance with ASTM D-2240, except the measurements are made on the curved surface of a molded ball component, rather than on a plaque. Furthermore, the Shore D hardness of the cover or intermediate layer is measured while the cover remains over the core. When a hardness measurement is made on a dimpled cover, Shore D hardness is measured at a land area of the dimpled cover.

Shore B Hardness

As used herein, “Shore B hardness” of a cover, intermediate layer or core is measured generally in accordance with the Shore D hardness determination set forth above with the exception that a more rounded stylus is utilized, except the measurements are made on the curved surface of a molded ball component, rather than on a plaque. Furthermore, the Shore B hardness of the cover or intermediate layer is measured while the cover remains over the core. When a hardness measurement is made on a dimpled cover, Shore D hardness is measured at a land area of the dimpled cover.

Coefficient of Restitution

The resilience or coefficient of restitution (COR) of a golf ball is the constant “e,” which is the ratio of the relative velocity of an elastic sphere after direct impact to that before impact. As a result, the COR (“e”) can vary from 0 to 1, with 1 being equivalent to a perfectly or completely elastic collision and 0 being equivalent to a perfectly or completely inelastic collision. COR, along with additional factors such as club head speed, club head mass, ball weight, ball size and density, spin rate, angle of trajectory and surface configuration (i.e., dimple pattern and area of dimple coverage) as well as environmental conditions (e.g., temperature, moisture, atmospheric pressure, wind, etc.) generally determine the distance a ball will travel when hit. Along this line, the distance a golf ball will travel under controlled environmental conditions is a function of the speed and mass of the club and size, density and resilience (COR) of the ball and other factors. The initial velocity of the club, the mass of the club and the angle of the ball's departure are essentially provided by the golfer upon striking. Since club head, club head mass, the angle of trajectory and environmental conditions are not determinants controllable by golf ball producers and the ball size and weight are set by the U.S.G.A., these are not factors of concern among golf ball manufacturers. The factors or determinants of interest with respect to improved distance are generally the coefficient of restitution (COR) and the surface configuration (dimple pattern, ratio of land area to dimple area, etc.) of the ball.

The COR in solid core balls is a function of the composition of the molded core and of the cover. The molded core and/or cover may be comprised of one or more layers such as in multi-layered balls. In balls containing a wound core (i.e., balls comprising a liquid or solid center, elastic windings, and a cover), the coefficient of restitution is a function of not only the composition of the center and cover, but also the composition and tension of the elastomeric windings. As in the solid core balls, the center and cover of a wound core ball may also consist of one or more layers. The coefficient of restitution is the ratio of the outgoing velocity to the incoming velocity. In the examples of this application, the coefficient of restitution of a golf ball was measured by propelling a ball horizontally at a speed of 125±5 feet per second (fps) and corrected to 125 fps against a generally vertical, hard, flat steel plate and measuring the ball's incoming and outgoing velocity electronically. Speeds were measured with a pair of Oehler Mark 55 ballistic screens available from Oehler Research, Inc., P.O. Box 9135, Austin, Tex. 78766, which provide a timing pulse when an object passes through them. The screens were separated by 36″ and are located 25.25″ and 61.25″ from the rebound wall. The ball speed was measured by timing the pulses from screen 1 to screen 2 on the way into the rebound wall (as the average speed of the ball over 36″), and then the exit speed was timed from screen 2 to screen 1 over the same distance. The rebound wall was tilted 2 degrees from a vertical plane to allow the ball to rebound slightly downward in order to miss the edge of the cannon that fired it. The rebound wall is solid steel 2.0 inches thick.

As indicated above, the incoming speed should be 125±5 fps but corrected to 125 fps. The correlation between COR and forward or incoming speed has been studied and a correction has been made over the ±5 fps range so that the COR is reported as if the ball had an incoming speed of exactly 125.0 fps.

The coefficient of restitution must be carefully controlled in all commercial golf balls if the ball is to be within the specifications regulated by the United States GolfAssociation (U.S.G.A.). As mentioned to some degree above, the U.S.G.A. standards indicate that a “regulation” ball cannot have an initial velocity exceeding 255 feet per second in an atmosphere of 75 oF, when tested on a U.S.G.A. machine. Since the coefficient of restitution of a ball is related to the ball's initial velocity, it is highly desirable to produce a ball having sufficiently high coefficient of restitution to closely approach the U.S.G.A. limit on initial velocity, while having an ample degree of softness (i.e., hardness) to produce enhanced playability (i.e., spin, etc.).

Compression

Compression is another important property involved in the performance of a golf ball. The compression of the ball can affect the playability of the ball on striking and the sound or “click” produced. Similarly, compression can affect the “feel” of the ball (i.e., hard or soft responsive feel), particularly in chipping and putting.

Moreover, while compression itself has little bearing on the distance performance of a ball, compression can affect the playability of the ball on striking. The degree of compression of a ball against the club face and the softness of the cover strongly influences the resultant spin rate. Typically, a softer cover will produce a higher spin rate than a harder cover. Additionally, a harder core will produce a higher spin rate than a softer core. This is because at impact a hard core serves to compress the cover of the ball against the face of the club to a much greater degree than a soft core thereby resulting in more “grab” of the ball on the clubface and subsequent higher spin rates. In effect the cover is squeezed between the relatively incompressible core and clubhead. When a softer core is used, the cover is under much less compressive stress than when a harder core is used and therefore does not contact the clubface as intimately. This results in lower spin rates.

The term “compression” utilized in the golfball trade generally defines the overall deflection that a golf ball undergoes when subjected to a compressive load. For example, PGA compression indicates the amount of change in golf ball's shape upon striking. The development of solid core technology in two-piece balls has allowed for much more precise control of compression in. comparison to thread wound three-piece balls. This is because in the manufacture of solid core balls, the amount of deflection or deformation is precisely controlled by the chemical formula used in making the cores. This differs from wound three-piece balls wherein compression is controlled in part by the winding process of the elastic thread. Thus, two-piece and multi-layer solid core balls exhibit much more consistent compression readings than balls having wound cores such as the thread wound three-piece balls.

In the past, PGA compression related to a scale of from 0 to 200 given to a golf ball. The lower the PGA compression value, the softer the feel of the ball upon striking. In practice, tournament quality balls have compression ratings around 70 to 110, preferably around 80 to 100. In determining PGA compression using the 0 to 200 scale, a standard force is applied to the external surface of the ball. A ball which exhibits no deflection (0.0 inches in deflection) is rated 200 and a ball which deflects 2/10th of an inch (0.2 inches) is rated 0. Every change of 0.001 of an inch in deflection represents a 1 point drop in compression. Consequently, a ball which deflects 0.1 inches (100×0.001 inches) has a PGA compression value of 100 (i.e., 200 to 100) and a ball which deflects 0.110 inches (110×0.001 inches) has a PGA compression of 90 (i.e., 200 to 110).

In order to assist in the determination of compression, several devices have been employed by the industry. For example, PGA compression is determined by an apparatus fashioned in the form of a small press with an upper and lower anvil. The upper anvil is at rest against a 200-pound die spring, and the lower anvil is movable through 0.300 inches by means of a crank mechanism. In its open position the gap between the anvils is 1.780 inches allowing a clearance of 0.100 inches for insertion of the ball. As the lower anvil is raised by the crank, it compresses the ball against the upper anvil, such compression occurring during the last 0.200 inches of stroke of the lower anvil, the ball then loading the upper anvil which in turn loads the spring. The equilibrium point of the upper anvil is measured by a dial micrometer if the anvil is deflected by the ball more than 0.100 inches (less deflection is simply regarded as zero compression) and the reading on the micrometer dial is referred to as the compression of the ball. In practice, tournament quality balls have compression ratings around 80 to 100 which means that the upper anvil was deflected a total of 0.120 to 0.100 inches.

An example to determine PGA compression can be shown by utilizing a golf ball compression tester produced by Atti Engineering Corporation of Newark, N.J. The value obtained by this tester relates to an arbitrary value expressed by a number which may range from 0 to 100, although a value of 200 can be measured as indicated by two revolutions of the dial indicator on the apparatus. The value obtained defines the deflection that a golf ball undergoes when subjected to compressive loading. The Atti test apparatus consists of a lower movable platform and an upper movable spring-loaded anvil. The dial indicator is mounted such that it measures the upward movement of the spring loaded anvil. The golf ball to be tested is placed in the lower platform, which is then raised a fixed distance. The upper portion of the golf ball comes in contact with and exerts a pressure on the spring loaded anvil. Depending upon the distance of the golf ball to be compressed, the upper anvil is forced upward against the spring.

Furthermore, additional compression devices may also be utilized to monitor golf ball compression so long as the correlation to PGA compression is known. These devices have been designed, such as a Whitney Tester, Instron Device, etc., to correlate or correspond to PGA compression through a set relationship or formula.

Herein, compression was measured using an Instron™ Device (model 5544), Instron Corporation, canton, Mass. Compression of a golf ball, core, or golf ball component is measured to be the deflection (in inches) caused by a 200 lb. load applied in a Load Control Mode at the rate of 15 kips, an approach speed of 20 inches per minute, with a preload of 0.2 lbf plus the system compliance of the device.

Cut Resistance

Cut is a ranking from 1 to 6 of the resistance to the ball cover of a cut, 1 being the best. Cut is measured by dropping a 5.9 lb weight from a height of 41″ onto a golf ball in a guillotine fashion, i.e., using a tester set up with a guillotine design. The ball is loosely held in a spherical cavity and the guillotine face strikes the approximate middle of the ball surface. The face of the guillotine is approximately 0.125 inches wide by 1.52 inches long and all edges are radiused in a bullnose fashion. The ball is struck in three different locations and is then assigned a ranking based on the degree of damage.

Scuff Resistance

Scuff is also a ranking from 1 to 6, 1 being the best, using a Titlist Vokey Sand Wedge to determine the susceptibility of the ball cover to scuffing from the club. A grooved Vokey Sand Wedge is mounted on the arm of a mechanical swing machine. The sand wedge is swung at 60 miles per hour and hits the ball into a capture net. The ball is hit three times, each time in a different location, and then assigned a ranking based on the degree of damage. The club face of the Vokey Sand Wedge has a groove width of 0.031 inches, cut with a mill cutter with no sandblasting or post finishing. Each groove is 0.018 inches deep and the space from one groove edge to the nearest adjacent groove edge is 0.138 inches. The total number of grooves is sixteen.

The exemplary embodiment is further illustrated by the following examples. It is to be understood that the exemplary embodiment is not limited to the examples, and various changes and modifications may be made in the exemplary embodiment without departing from the spirit arid scope thereof.

### EXAMPLES

A series of golfballs produced in accordance with the exemplary embodiment and using the exemplary embodiment molding assembly, exhibited the following dimensions, weight, compression, and coefficient of restitution (COR).

| | Off/Equa | Equator | Weight | | |
|---|---|---|---|---|---|
| Ball No. | (inches) | (inches) | (grams) | Comp. | (COR) |
| 1 | 1.68400 | 1.68585 | 45.87 | 0.0853 | 0.7954 |
| 2 | 1.68780 | 1.68535 | 45.79 | 0.0872 | 0.7955 |
| 3 | 1.68675 | 1.68480 | 45.68 | 0.0833 | 0.7964 |
| 4 | 1.68890 | 1.68725 | 45.96 | 0.0875 | 0.7960 |
| 5 | 1.68315 | 1.68120 | 45.68 | 0.0851 | 0.7945 |
| Mean | 1.68612 | 1.68489 | 45.80 | 0.0857 | 0.7956 |
| St. Dev. | 0.00246 | 0.00225 | 0.12 | 0.0017 | 0.0007 |
| Max. | 1.68890 | 1.68725 | 45.96 | 0.0875 | 0.7964 |
| Min. | 1.68315 | 1.68120 | 45.68 | 0.0833 | 0.7945 |

The dimensional data, i.e. the “Off/Equa.” and “Equator” diameters indicate the consistent golf ball diameters achievable by use of the exemplary embodiment. It is significant to note the extremely low values of standard deviation for both of these measurements. Furthermore, variations in weight, compression, and COR were well within acceptable limits. This data reveals the highly consistent and uniform golf balls produced in accordance with the exemplary embodiment. All patents and patent applications cited in the foregoing text are expressly incorporated herein by reference in their entirety.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

We claim as our invention:

1. A two stage reaction method for forming a layer on a golf ball core or intermediate golf ball assembly, the method comprising:
providing a first mold defining a recessed molding surface;
providing a second mold defining a recessed retaining surface;
positioning a golf ball core or intermediate golf ball assembly within at least one of the recessed molding surface of the first mold and the recessed retaining surface defined by the second mold;
closing the first mold and the second mold whereby a first molding cavity is defined along a first region of the golf ball core or intermediate golf ball assembly;
introducing an initially flowable material into the first molding cavity to thereby form a first molded layer portion on the first region;
opening the first mold and the second mold to thereby at least partially expose the golf ball core or intermediate golf ball assembly;
providing a third mold defining a recessed molding surface;
positioning the golf ball core or intermediate golf ball assembly containing the first molded layer portion within at least one of the recessed molding surface of the first mold and the recessed molding surface of the third mold;
closing the first mold and the third mold whereby a second molding cavity is defined along a second region of the golf ball core or intermediate golf ball assembly;
introducing an initially flowable material into the second molding cavity to thereby form a second molded layer portion on the second region;
opening the first mold and the third mold;
removing the golf ball core or the intermediate golf ball assembly containing the first and second molded layer portions, from at least one of the first mold and the third mold.

2. The method of claim 1, wherein the first molded layer portion covers about one-half of the surface of the golf ball core or intermediate golf ball assembly.

3. The method of claim 1, wherein the second molded layer portion covers about one-half of the surface of the golf ball core or intermediate golf ball assembly.

4. The method of claim 1, wherein the molding surface of the first mold defines a plurality of dimpled projections.

5. The method of claim 1, wherein the molding surface of the third mold defines a plurality of dimpled projections.

6. The method of claim 1, wherein the initially flowable material includes reactants that combine to form polyurethane.

7. The method of claim 6 where the material forming process has a cycle time of less than 90 seconds.

8. The method of claim 1, wherein the removing operation is performed by applying an ejection force to the golf ball core or the intermediate golf ball assembly.

9. A molding assembly adapted for two stage reaction injection molding, the molding assembly comprising:
a first mold defining a recessed molding surface;
a second mold defining a recessed retaining surface, wherein the first mold and the second mold are adapted to engage each other to form a first molding cavity; and
a third mold defining a recessed molding surface, wherein the first mold and the third mold are adapted to engage each other to form a second molding cavity.

10. The molding assembly of claim 9, wherein at least one of the molding surface of the first mold and the molding surface of the third mold define a plurality of dimpled projections.

11. The molding assembly of claim 9, wherein the third mold includes a movable ejection pin having a distal tip, the pin movable such that the tip can be extended into the recessed molding surface defined in the third mold.

12. The molding assembly of claim 11, wherein the ejection pin defines a plurality of dimpled projections on the distal tip.

13. The molding assembly of claim 9, wherein the second mold defines a chamfered lip extending about the periphery of the recessed retaining surface.

14. The molding assembly of claim 13, wherein the second mold defines a face for engagement with the first mold, and the chamfered lip extends at an angle with respect to the face, of from about 10° to about 80°.

15. A method of molding a layer formed of at least one flowable reactive material about a golf ball product, comprising:
holding a first portion of the golf ball product in a retaining cavity of a retaining member to expose a second portion of the golf ball product;
positioning the exposed second portion of the golf ball product in a first mold cavity of a first mold portion;
injecting the reactive material at a mating surface between the retaining member and the first mold portion into the first mold cavity to mold a first portion of the layer over the second portion of the golf ball product;
disengaging the retaining member from the golf ball product to expose the first portion thereof while holding the molded first portion of the layer by the first mold portion;
positioning the exposed first portion of the golf ball product in a second mold cavity of a second mold portion;
injecting the reactive material at a mating surface between the first and second mold portions into the second mold cavity to mold a second portion of the layer over the first portion of the golf ball product; and
removing the golf ball product with the molded layer from the first and second molded portions.

16. The method of claim 15, wherein the holding the golf ball product in the retaining cavity comprises placing the golf ball product into the retaining cavity to form an interference fit that is substantially hemispherical and has a radius substantially equal to that of the golf ball product.

17. The method of claim 15, wherein the holding the golf ball product in the retaining cavity comprises placing the golf ball product into the retaining cavity to form an interference fit that is substantially hemispherical and free of openings.

18. The method of claim 15, wherein the retaining member comprises at least one through opening in communication with the retaining cavity for air or inert gas to flow into or out of the retaining cavity.

19. The method of claim 18, wherein a negative or positive pressure is applied to the retaining cavity via the at least one through opening during the step of holding the golf ball product in the retaining cavity or the step of disengaging the retaining member from the golf ball product, respectively.

20. The method of claim 15, wherein the disengaging the retaining member from the golf ball product comprises:
extending one or more retractable elements into the retaining cavity; and
expelling the golf ball product out of the retaining member.

21. The method of claim 15, wherein the positioning the second portion of the golf ball product in the first mold cavity comprises:
mating the first mold portion with the retaining member at a mating surface;
extending one or more supporting members through the first mold portion into the first mold cavity to engage with the second portion of the golf ball product; and
holding the golf ball product with the supporting members and the retaining member.

22. The method of claim 15, wherein the first mold portion comprises at least one through opening in communication with the first mold cavity for air or inert gas to flow into or out of the first mold cavity.

23. The method of claim 22, wherein a negative or positive pressure is applied to the first mold cavity via the at least one through opening during the step of holding the molded first portion of the layer or the step of removing the molded layer from the mold portions, respectively.

24. The method of claim 15, wherein the positioning the first portion of the golf ball product in the second mold cavity comprises:
mating the first mold portion with the second mold portion at a mating surface;
extending one or more supporting members through the second mold portion into the second mold cavity to engage with the first portion of the golf ball product; and
holding the golf ball product with the supporting members and the first mold portion.

25. The method of claim 15, wherein the second mold portion comprises at least one through opening in communication with the second mold cavity for air or inert gas to flow into or out of the second mold cavity.

26. The method of claim 25, wherein a negative or positive pressure is applied to the second mold cavity via the at least one through opening during the step of holding the molded second portion of the layer or the step of removing the molded layer from the mold portions, respectively.

27. The method of claim 15, wherein the retaining member is stationary, or mobile but independent of the second mold portion.

28. The method of claim 15, wherein at least one of the retaining member, the first mold portion, and the second mold portion is detachably affixed to at least one of the first and second mold platens.

29. The method of claim 15, wherein the layer is an outer cover layer, an inner cover layer, an intermediate layer, a dimpled layer, a lattice network layer, or a discontinuous layer comprising a plurality of discrete elements.

30. The method of claim 15, wherein the layer has a thickness of 0.03 inches or less.

31. The method of claim 15, wherein the forming the layer comprises overlapping the first and second molded portions at one or more locations by a width of 0.0005 inches or greater.

32. A method of molding a layer formed of at least one reaction injection molding material about each golf ball product in a multi-array of golf ball products comprising:
holding a first portion of each golf ball product in a retaining cavity of a multi-array of a retaining member to expose a second portion of each golf ball product;
positioning the exposed second portion of each golf ball product in a first mold cavity of a multi-array of first mold portions;
molding a first portion of the layer from a reaction injection molding material over the second portion of each golf ball product;
disengaging the retaining member array from the golf ball product array to expose the first portion of each golf ball product while holding the molded first portions of the layers by the first mold portion array;
positioning the exposed first portion of each golf ball product in a second mold cavity of a multi-array of second mold portions;
molding a second portion of the layer from the reaction injection molding material over the first portion of each golf ball product; and
removing the golf ball product with the molded layer from the first and second molded portions.

33. The method of claim 32, wherein the retaining member array and the second mold portion array are detachably affixed to a common mold platen and interleave with each other.

34. The two-stage reaction method of claim 32, wherein each molding step comprises from about 10 seconds to about 600 seconds.

35. The two-stage reaction method of claim 32, wherein each molding step comprises from about 30 seconds to about 300 seconds.

36. The two-stage reaction method of claim 32, wherein each molding step comprises from about 60 seconds to about 120 seconds.

37. A method of molding a layer formed of at least one reaction injection molding material about a golf ball product, comprising:
holding a bottom portion of the golf ball product horizontally in a retaining cavity of a retaining member to expose a top portion of the golf ball product;
positioning the exposed top portion of the golf ball product in a top mold cavity of a top mold portion;
injecting the reaction injection molding material at a mating surface between the retaining member and the top mold portion into the top mold cavity to mold a top portion of the layer over the top portion of the golf ball product;
disengaging the retaining member from the golf ball product to expose the bottom portion thereof while holding the molded top portion of the layer by the top mold portion;
positioning the exposed bottom portion of the golf ball product in a bottom mold cavity of a bottom mold portion;
injecting the reaction injection molding material at a mating surface between the top and bottom mold portions into the bottom mold cavity to mold a bottom portion of the layer over the bottom portion of the golf ball product; and
removing the golf ball product with the molded layer from the first and second molded portions.

38. The two-stage reaction method of claim 37, wherein each molding step comprises from about 10 seconds to about 600 seconds.

39. The two-stage reaction method of claim 37, wherein each molding step comprises from about 30 seconds to about 300 seconds.

40. The two-stage reaction method of claim 37, wherein each molding step comprises from about 60 seconds to about 120 seconds.

41. The method of claim 37, wherein each molded portion fuses together to form a continuous layer.

42. The method of claim 15, wherein each molded portion fuses together to form a continuous layer.

43. The method of claim 1, wherein each molded portion fuses together to form a continuous layer.
